(19) United States
(12) Patent Application Publication
(10) Pub. No.: US 2012/0187690 A1
(43) Pub. Date: Jul. 26, 2012

(54) HYDROELECTRIC GENERATORS

(76) Inventors: Randal D. Walton, Reno, NV (US); Michael E. Walton, Napa, CA (US)

(21) Appl. No.: 13/011,828

(22) Filed: Jan. 21, 2011

(51) Int. Cl. F03B 13/08

(52) U.S. Cl. 290/54

(57) ABSTRACT

Hydroelectric generators for harnessing potential energy from a flowing liquid source with a varying surface level. Hydroelectric generators may comprise platforms with buoyancies selected to remain suspended in the liquid source at a selected depth. In some examples, generation units may be fixed to the platform, the generation unit including turbines partially submerged in the liquid source, generators drivingly connected to the wheel, and electrical interfaces connected to the generator, the electrical interface configured to connect to an external power system. In some examples, hydroelectric generators may include one or more anchors connected to the platform. In some examples, generation units may include rotors. In some examples, hydroelectric generators may include projections extending into the liquid source and define channels between the projections.

### CROSS-REFERENCE TO RELATED APPLICATIONS

This application is a continuation-in-part of, and claims priority to, copending application Ser. No. 13/184,388, filed on Jul. 15, 2011, which is a continuation-in-part of, and claims priority to, copending application Ser. No. 13/037,711, filed on Mar. 1, 2011, which is a continuation-in-part of, and claims priority to, copending application Ser. No. 13/011,828 filed on Jan. 21, 2011. Each previously referenced application is hereby incorporated by reference.

### BACKGROUND

The present disclosure relates generally to hydroelectric generators. In particular, hydroelectric generators that provide efficiency gains through the accumulation of a potential energy within a fluid in a collecting body prior to communicating the fluid to a generation unit including a turbine and generator. Such efficiency gains are particularly suited to contexts in which a fluid input's potential energy would otherwise be insufficient to power a hydroelectric generator.

In particular, such hydroelectric generators may be particularly suited to collect liquid waste routed through storm water and sewage disposal systems. Fluid from such systems may be harnessed: within structures wherein the liquid waste and storm water are collected and within community liquid waste sewage systems. Implementing a collection body to accumulate a potential energy is beneficial in such contexts due to the variance in flow levels inherent in these systems.

Hydroelectric generators that accumulate potential energy within a collection body may also be useful in contexts with upstream generators, particularly those located within hydroelectric dams. Accumulating liquid output from either a dam or spillway attached to the dam and releasing it more efficiently harnesses potential energy from these sources than would otherwise be underutilized.

Turbines within hydroelectric generators provide an additional opportunity to accumulate potential energy within a liquid body. Specifically, vertically arranged turbines may be designed with collection bodies within the turbines' blades, wherein the turbines are configured to rotate only after a selected quantity of liquid has been collected between the blades. Such a design may be useful in the low flow contexts described above.

The present disclosure additionally relates to various hydroelectric generators designs, wherein the generators are arranged in series in a plural, cascaded arrangement. Such hydroelectric generators provide efficiency gains by utilizing a fluid's potential energy as it cascades over a plurality of generators in series rather than to power a solitary generator.

Using liquid waste for hydroelectricity creates a need for a means of breaking up solid waste sometimes communicated along with the liquid waste.

### SUMMARY

The present disclosure is directed to hydroelectric generators addressing the needs described in the above Background. Specifically, examples of hydroelectric generators that harness underutilized liquid sources are provided. Several examples implementing cascading systems are provided, wherein a plurality of generators are used in series maximize the generation of electricity in hydroelectric generators. While this disclosure discusses designs outside of any particular context, this disclosure also specifically describes examples of such systems implemented within liquid waste disposal systems and hydroelectric dam contexts.

Additionally, this disclosure provides examples of hydroelectric generators that accumulate potential energy within a liquid collected by a collection body prior to communicating the liquid to a generator. Such hydroelectric generators are designed to harness the potential energy of liquid source from low flow sources that would otherwise be underutilized. This disclosure provides examples of hydroelectric generators that harness potential energy in various ways, including by implementing collection bodies that define funnels and pipes in fluid communication with a generator and by implementing collection bodies between the blades of vertically oriented turbines.

In addition to the examples described above, this disclosure discusses approaches to minimizing the potential for harm that solid waste may introduce into hydroelectric generator systems. Specifically, this disclosure contemplates solid waste dispersal members that are designed to move about the collection bodies. This disclosure additionally contemplates a means for powering the movement of these waste dispersal members by the same liquid source used to power the downstream generator.

In some examples of hydroelectric generators may harness potential energy from a flowing liquid source with a varying surface level. Such hydroelectric generators may include platforms with buoyancies selected to remain suspended in the liquid source at a selected depth. In some examples, generation units may be fixed to the platform, the generation units including turbines partially submerged in the liquid source, a generators drivingly connected to the wheel, and electrical interfaces connected to the generator, the electrical interface configured to connect to an external power system. In some examples, hydroelectric generators may include one or more anchors connected to the platform. In some examples, generation units may include rotors. In some examples, hydroelectric generators may include projections extending into the liquid source and define channels between the projections.

### BRIEF DESCRIPTION OF THE DRAWINGS

FIG. 1 is a side elevation view of a first example of a hydroelectric generator.

FIG. 2 is a perspective view of the hydroelectric generator shown in FIG. 1.

FIG. 3 is a perspective view of the hydroelectric generator shown in FIG. 1 implementing a hydroelectric generator's output as a liquid source.

FIG. 4 is a perspective view of a second example of a hydroelectric generator that includes a first cascaded generation unit and a second cascaded generation unit that uses the first cascaded generation unit's output as a liquid source.

FIG. 5 is a side elevation view of a third example of a hydroelectric generator wherein water collects between a collection of turbine blades to apply torque to a turbine.

FIG. 6 is a side elevation view of a fourth example of a hydroelectric generator including three vertically organized turbines arranged with substantially alternating orientations.

FIG. 7 is a side elevation view of a fourth example of a hydroelectric generator including three vertically organized turbines arranged with similar orientations.

FIG. 8 is a side elevation view of a fifth example of a hydroelectric generator wherein the output of the hydroelectric generator shown in FIG. 6 is routed to the input of the hydroelectric generator shown in FIG. 1.

FIG. 9 is a perspective view of a sixth example of a hydroelectric generator wherein storm water and sewage disposal systems within a building rotate a collection of turbines and generators.

FIG. 10 is a perspective view of the hydroelectric generator illustrated in FIG. 9 wherein the building elements are removed to better show internal components.

FIG. 11 is a perspective cut-away view of a system for handling solid waste included in hydroelectric generators.

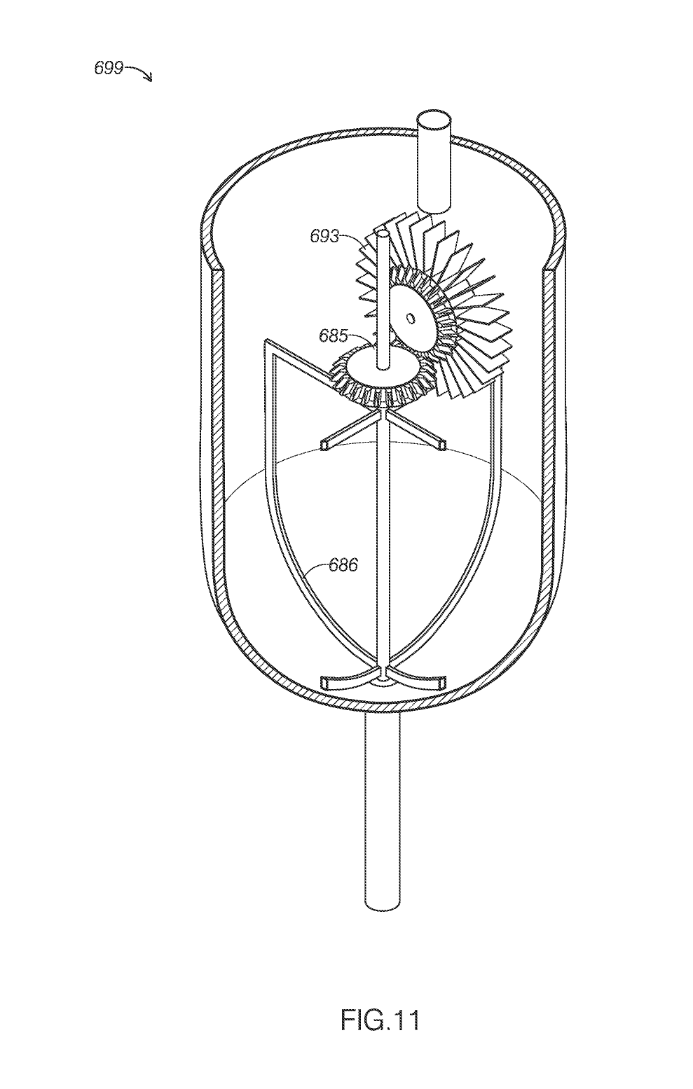

FIG. 12 is a perspective view of a seventh example of a hydroelectric generator wherein storm water and sewage disposal systems within a building rotate turbines and generators on alternating floors within the building.

FIG. 13 is perspective view of an eighth example of a hydroelectric generator that collects and routes liquid from a spillway routed over the top of a dam including a hydroelectric generator using the liquid to rotate a turbine and generator.

FIG. 14 is a perspective view of a ninth example of a hydroelectric generator, the generator receiving fluid from a spillway pipe that bypasses a dam including a hydroelectric generator.

FIG. 15 is a perspective view of a tenth example of a hydroelectric generator, the hydroelectric generator routing fluid output from a generator within a hydroelectric dam to a collection of horizontally oriented turbines and generators.

FIG. 16 is a perspective view of an eleventh example of a hydroelectric generator, the hydroelectric generator routing fluid output from a generator within a hydroelectric dam to a collection of vertically oriented turbines and generators.

FIG. 17 is a perspective view of a twelfth example of a hydroelectric generator that includes a spillway pipe and a spillway release pipe attached to the spillway pipe.

FIG. 18 is a perspective view of a thirteenth example of a hydroelectric generator that includes a siphon pipe routed over the top of a hydroelectric dam.

FIG. 19 is a perspective view of a fourteenth example of a hydroelectric generator that includes a siphon with a first end below the input of a hydroelectric generator within the hydroelectric dam.

FIG. 20 is a perspective view of a fifteenth example of a hydroelectric generator that includes a siphon pipe routed over the top of a hydroelectric dam.

FIG. 21 is a perspective view of a sixteenth example of a hydroelectric generator positioned near a cascading water feature and including downstream generators.

FIG. 22 is a side elevation view the hydroelectric generator shown in FIG. 21 illustrating a first stage.

FIG. 23 is a perspective view of the hydroelectric generator shown in FIG. 21 illustrating details of an intake and a columnar conduit.

FIG. 24 is a perspective view of a downstream generator of the hydroelectric generator shown in FIG. 21 with a generator housing partially cut away to show its interior components.

FIG. 25 is a side elevation view of a downstream generator of the hydroelectric generator shown in FIG. 21 with a generator housing partially cut away to show its interior components.

FIG. 26 is a top view of the downstream generators shown in FIG. 21.

FIG. 27 is a perspective view of a seventeenth example of a hydroelectric generator.

FIG. 28 is a perspective view of the hydroelectric generator shown in FIG. 27 operating in parallel with two similar hydroelectric generators.

FIG. 29 is a perspective view of an eighteenth example of a hydroelectric generator.

FIG. 30 is a rear elevation view of the hydroelectric generator shown in FIG. 29 depicting a generation unit partially submerged in a liquid source.

FIG. 31 is a perspective view of a nineteenth example of a hydroelectric generator.

FIG. 32 is a rear elevation view of the hydroelectric generator shown in FIG. 31.

FIG. 33 is a side elevation view of the hydroelectric generator shown in FIG. 31 depicting the hydroelectric generator in a lowered configuration in phantom lines.

FIG. 34 is a perspective view of a twentieth example of a hydroelectric generator.

FIG. 35 is a perspective view of a twenty first example of a hydroelectric generator.

FIG. 36 is a perspective view of a twenty second example of a hydroelectric generator.

### DETAILED DESCRIPTION

The disclosed hydroelectric generators will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various hydroelectric generators are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

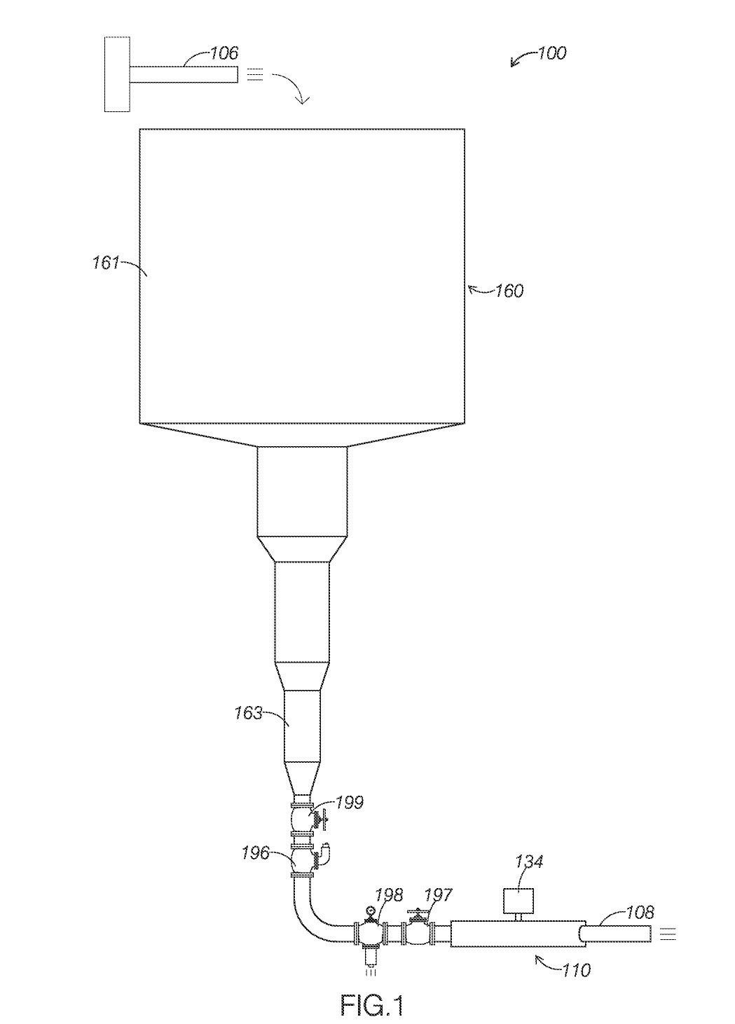

With reference to FIGS. 1-3 a hydroelectric generator 100 includes a liquid source 106, a collection body 160, a generation unit 110, and an output pipe 108. Hydroelectric generator 100 generally functions to collect a quantity of a liquid from liquid source 106 and build head pressure prior to allowing the liquid to flow through generation unit 110.

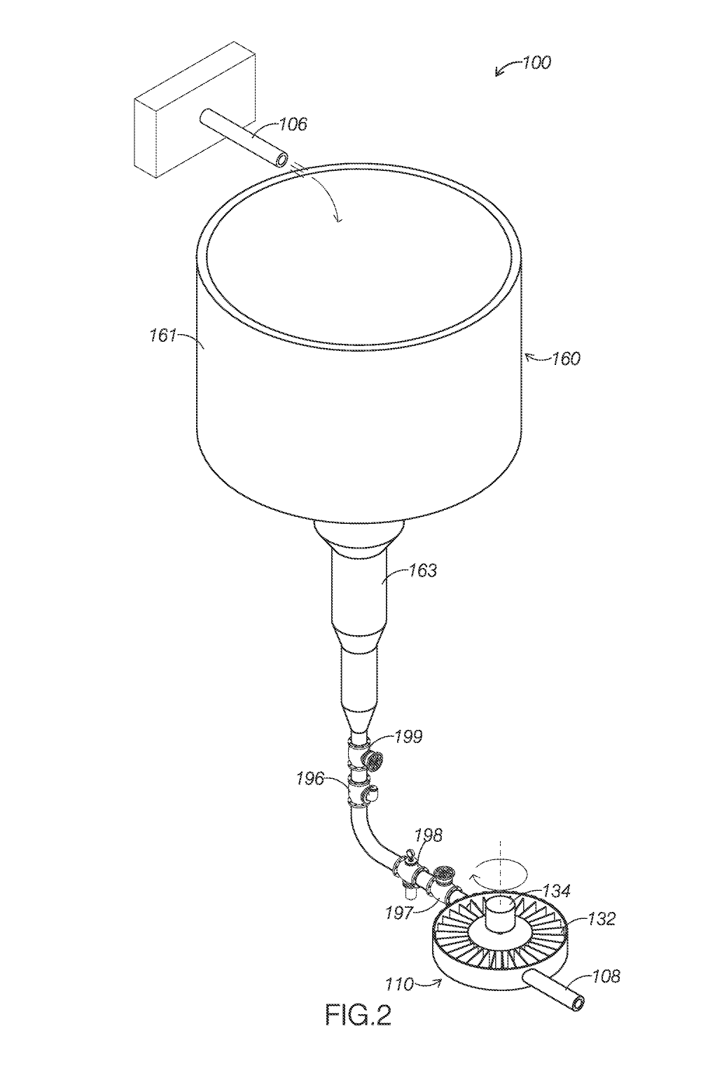

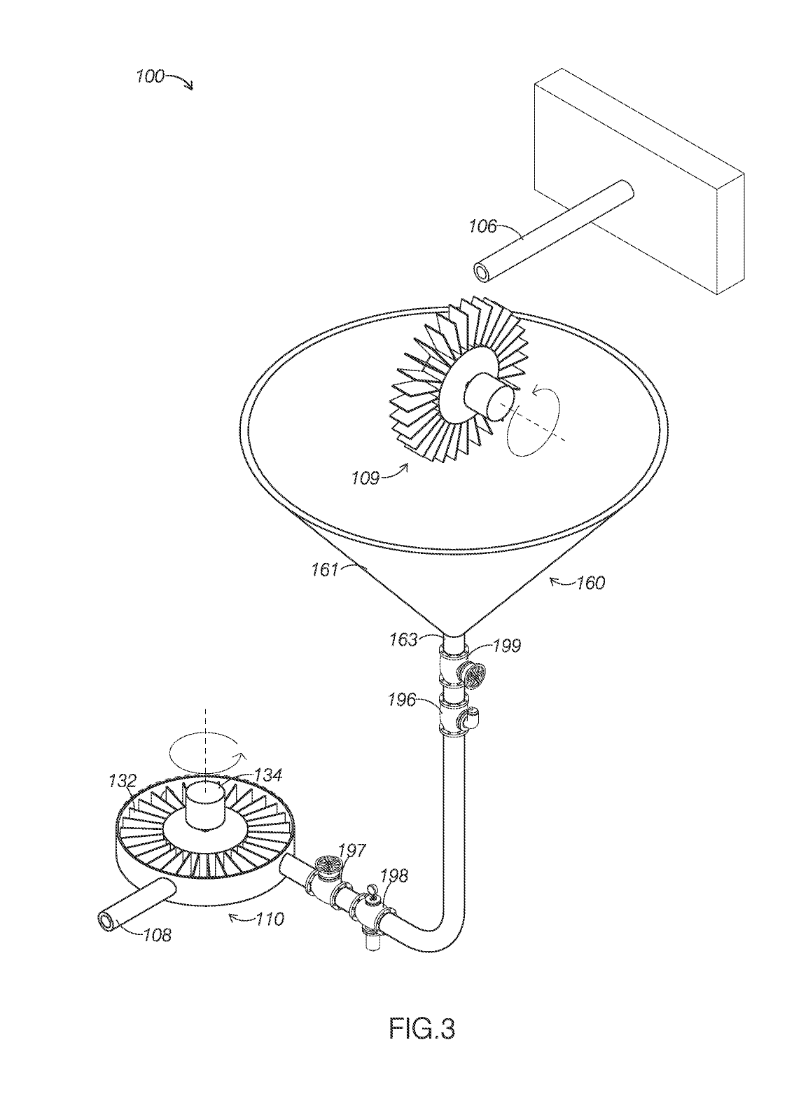

As FIGS. 1-3 show, liquid source 106 includes a pipe configured to direct liquid substantially into collection body 160. Liquid source 106 is illustrated in FIGS. 1-2 as a single pipe, however liquid source 106 may comprise many forms, including multiple pipes, vessels, bodies of liquid, and other fluid systems. For example, liquid source 106 may a conduit transporting pipe, natural fluid sources such as rainfall, streams, or rivers, or the output from other hydraulic and/or hydroelectric generation systems. FIG. 3 illustrates hydroelectric generator 100 in such an alternative context wherein liquid source 106 includes the output of an external hydroelectric generation system 109.

Collection body 160 includes a storage tank 161, and a head pipe 163 connected to an opening substantially at the bottom of storage tank 161. Collection body 160 is configured to collect the liquid output from liquid source 106 and accumulate potential energy from the liquid contained within collection body 160 prior to communicating liquid to generation unit 110.

Storage tank 161 defines a container at a position below liquid source 106 configured to collect the liquid output from liquid source 106. Storage tank 161 defines an opening on its top end configured to collect liquid from liquid source 106 and an opening on its bottom end opening to head pipe 163.

Head pipe 163 defines a pipe that is connected to storage tank 161 on one end and generation unit 110 on the opposite end. Head pipe 163 configured to allow the liquid contained in storage tank 161 to pass to generation unit 110. The opening defined by the connection between head pipe 163 and generation unit 110 has a smaller area than the opening defined by the connection between head pipe 163 and storage tank 161. Head pipe 163 tapers from the width of storage tank 161 to the diameter of head pipe 163 along a portion of its length to define a funnel.

Head pipe 163 is configured to increase the flow rate of the fluid prior to communicating it to generation unit 110. Accumulating a reservoir of fluid feeding head pipe 163 under pressure and increasing the flow rate within head pipe 163 makes use of Bernoulli's Principal for more efficient for more efficient electricity generation downstream.

Accumulating potential energy within a contained liquid prior to sending the liquid to generation unit 110 encourages more efficient generation of electrical energy in hydroelectric contexts. Specifically, collecting liquid to generate a head prior to passing the liquid to the generation unit may allow liquid from low-flow sources to drive hydroelectric turbines and/or generators in contexts where flow alone would be otherwise insufficient. Additionally, some liquid received from liquid source 106 that would otherwise bypass hydroelectric generator 100 when operating at capacity may be stored within collection body 160 for future use.

Hydroelectric generator 100 additionally includes a valve 197 and gauge 198 positioned on head pipe 163 proximate generation unit 110.

Gauge 198 is configured to detect and display the current amount of pressure accumulated within head pipe 163. Gauge 198 is operationally connected with valve 197 to allow gauge 198 to communicate with valve 197.

Valve 197 is configured to open and release excess gas or liquid within head pipe 163 to substantially prevent damage to hydroelectric generator 100 resulting from an excess of liquid or gas pressure. Additionally, valve 197 is configured to open and close the connection between head pipe 163 and generation unit 110. Valve 197 may be operated manually or automatically in concert with gauge 198, wherein valve 197 is configured to release a selected amount of gas and/or liquid from head pipe 163 upon gauge 198 detecting a selected amount of pressure within head pipe 163.

Hydroelectric generator 100 additionally includes a second valve 199 positioned upstream of valve 197. Second valve 199 provides additional control of the amount of liquid and pressure contained within hydroelectric generator 100.

Hydroelectric generator 100 includes an air release valve 196 proximate second valve 199, configured to release excess air within head pipe 163.

As FIGS. 2-3 illustrate, generation unit 110 defines an enclosed space that opens on one end to head pipe 163 and to output pipe 108 on the opposite end. Generation unit 110 includes a turbine 132 drivingly attached to a generator 134, both of which are located within the enclosed space. Generator 134 generates electrical energy as turbine 132 rotates. Generator 134 is additionally configured too connect to an external power system, allowing the distribution and/or storage of generated electrical energy.

Generation unit 110 is illustrated in FIG. 2-3 as having an open top. However, illustrating generation unit 110 in this manner is illustrative in purpose, specifically to show generation unit 110's internal components. In most contexts, generation units similar to generation unit 110 are fully enclosed, as this allows more efficient generation of electrical energy.

Turbine 132 includes a collection of turbine blades that project radially around its perimeter and fill substantially all of the space within the enclosed space of generation unit 110. As liquid flows from head pipe 163 through generation unit 110, the liquid applies a torque to the turbine blades causing turbine 132 to rotate. As turbine 132 rotates, it drives generator 134, which converts the mechanical energy of turbine 132's rotation in to electrical energy.

Output pipe 108 is open on one end and connects to generator 134 on the opposite end. Output pipe 108 routes the liquid that has flowed through generation unit 110 to its opening on the opposite side. Though output pipe 108 is routed towards an undefined destination in FIGS. 1-3, output pipe 108 may be used to route the liquid output from hydroelectric generator 100 to a specific destination. For example, output pipe 108 may be used to output the liquid to a sewage line or waste utility. Output pipe 108 may additionally be used to route the output of hydroelectric generator 100 to a second hydroelectric generator. In this manner, output pipe 108 may define a liquid source for a second hydroelectric generator.

Hydroelectric generator 100 may be applied to many various contexts, particularly including those with a less than ideal liquid flow. However, this disclosure specifically contemplates implementing hydroelectric generator 100 in community liquid waste disposal systems, including storm water drainage systems and sewage systems in particular. In such contexts, hydroelectric generator 100 or multiple hydroelectric generators 100 may be placed in series at any point along the liquid waste disposal systems. Implementing hydroelectric generator 100 in this context harnesses a source of hydroelectric energy that is currently underutilized.

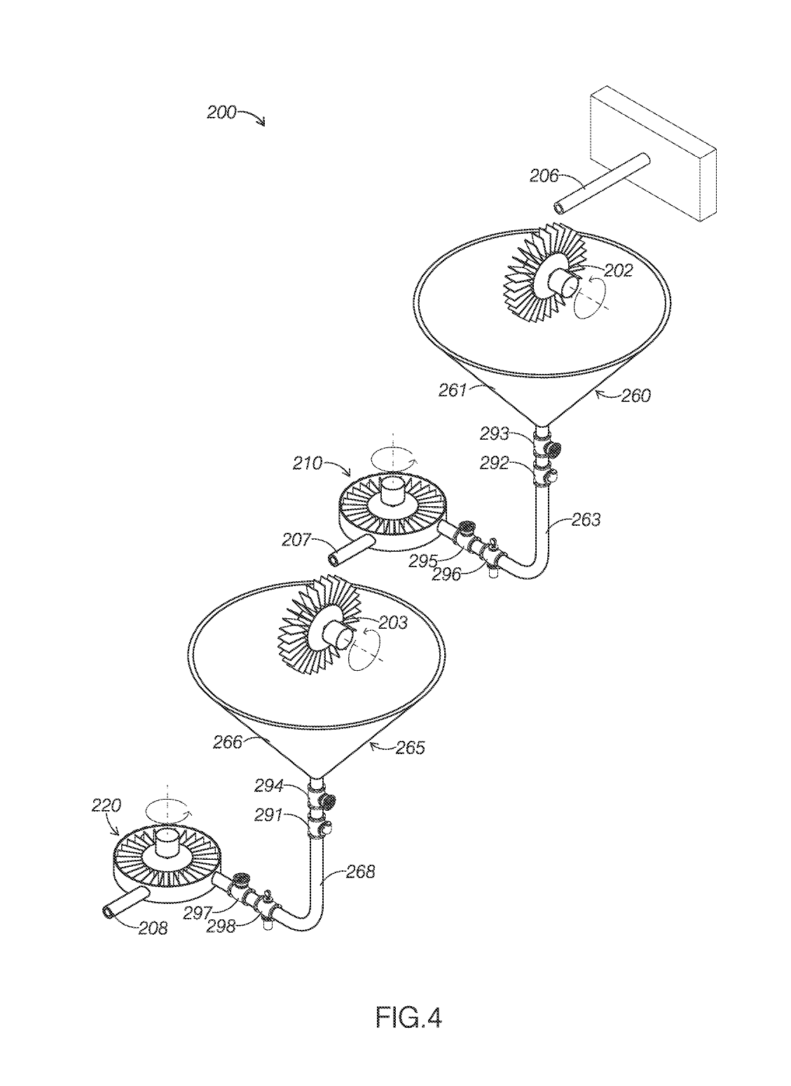

Turning attention to FIG. 4, a second example of a hydroelectric generator 200 will now be described. Specifically, hydroelectric generator 200 serves an example of a hydroelectric generator in which the output serves as a liquid source of a second hydroelectric generator. Hydroelectric generator 200 includes many similar or identical features to hydroelectric generator 100 combined in unique and distinct ways. Thus, for the sake of brevity, each feature of hydroelectric generator 200 will not be redundantly explained. Rather, key distinctions between hydroelectric generator 100 and hydroelectric generator 200 will be described in detail and the reader should reference the discussion above for features substantially similar between the two hydroelectric generators.

Hydroelectric generator 200 includes a first cascaded unit and a second cascaded unit downstream of the first cascaded unit, each of which is substantially similar to hydroelectric generator 100. Specifically, the first cascaded unit includes a liquid source 206, a first collection body 260, a first generation unit 210, and a first cascaded unit output 207. The second cascaded unit includes a second collection body 265, a second generation unit 220, and an output pipe 208.

First collection body 260 includes a first storage tank 261 and a first head pipe 263. These elements are configured to accumulate potential energy by containing a volume of liquid prior to sending the liquid to first generation unit 210, similar to the corresponding elements of hydroelectric generator 100.

Likewise, second collection body 265 includes a second storage tank 266 and a second head pipe 268. These elements are configured to accumulate potential energy by containing a volume of liquid prior to sending the liquid to second generation unit 220, similar to the corresponding elements of hydroelectric generator 100.

The first cascaded unit additionally includes a first valve 295 and first gauge 296, and the second cascaded unit includes a second valve 297 and second gauge 298. These elements are substantially similar to valve 197 and gauge 198; however, this disclosure additionally contemplates second gauge 298 being operationally connected to first valve 295. Connecting second gauge 298 to first valve 295 enables second gauge 298 to communicate pressure and liquid levels within the second cascaded unit and to allow first valve 295 to substantially control the flow rate of first cascaded unit output 207's.

Additionally, the first cascaded unit includes a first upstream valve 293 and a first upstream air release valve 292. The second cascaded unit includes a second upstream valve 294 and a second upstream air release valve 291. First upstream valve 293, second upstream valve 294, first upstream air release valve 292, and second upstream air release valve 291 are each substantially similar to the corresponding elements of hydroelectric generator 100.

Hydroelectric generator 200 substantially defines two hydroelectric generators similar to hydroelectric generator 100 positioned in a cascaded arrangement. Specifically, first cascaded unit output 207 functions as both the output of the first cascaded unit and a liquid source of the second cascaded unit. Stated differently, the output of the first cascaded unit is collected in second storage tank 266, whereupon it is stored to generate a head pressure prior to flowing through second generation unit 220.

Liquid source 206 is similar to liquid source 106, and may include any source of liquid previously mentioned in connection with liquid source 106. Additionally, though the second cascaded unit is configured specifically to collect water output from first cascaded unit output 207, it may collect liquid from other sources as well.

Routing the output of the first cascaded unit to serve as a liquid source of the second cascaded unit illustrates the concept of cascading multiple hydroelectric generators in series. Organizing hydroelectric generators in such a manner harnesses a liquid source at multiple stages, and leads to efficiency gains through using the same liquid source to generate electricity multiple times prior to discarding the liquid.

Although hydroelectric generator 200 includes two generators positioned in a cascaded organization, any number of hydroelectric generators positioned in a cascaded arrangement may be used. When multiple hydroelectric generators are employed, the output of each generator serves as an input for the subsequent generator, save the final output. The inventive subject matter of this disclosure, in relevant part, relates more to the cascaded organization of hydroelectric generators seen in hydroelectric generator 200 than the numerosity of the generators.

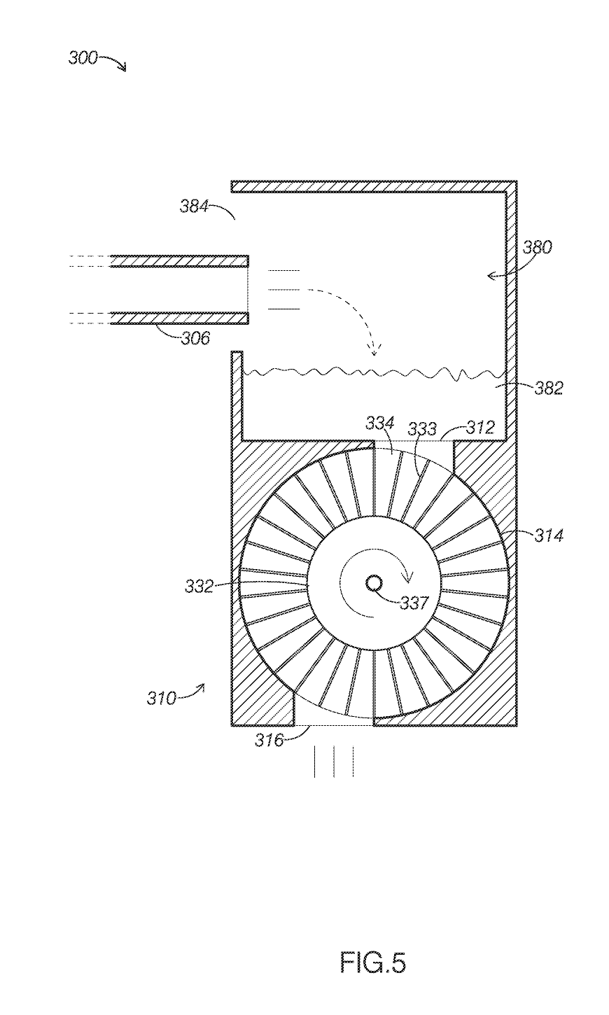

Turning attention to FIG. 5, a third example of a hydroelectric generator 300 will now be described. Hydroelectric generator 300 includes a liquid source 306, a liquid collector 380 and a generation unit 310.

Collection area 382 includes a collection area 382 and a pressure release 384. Collection area 382 defines a receptacle positioned substantially above generation unit 310 and is configured to collect and store liquid from liquid source 306. As liquid collects in collection area 382, pressure release 384 is configured to release pressure within a liquid collector 380, thereby assisting the maintenance of safe pressure levels within hydroelectric generator 300. Generation unit 310 includes a liquid input 312, a turbine space 314, and a liquid output 316. Hydroelectric generator 300 additionally includes a turbine 332 disposed within turbine space 314 which is drivingly connected to a generator 337.

Turbine 332 is disposed within turbine space 314 and includes a collection of turbine blades 333 that project radially from turbine 332 to fill substantially all of turbine space 314. Turbine blades 333 include a plurality of collecting bodies 334 defining containers positioned between each adjacent pair of turbine blades.

Hydroelectric generator 300 is configured to route liquid contained in collection area 382 to turbine space 314 via liquid input 312. As the liquid enters turbine space 314, within collecting bodies 334. The accumulating liquid accumulates potential energy resulting from gravity acting on the increasing mass of liquid.

As the liquid contained in collecting bodies 334 increases in mass and potential energy, the liquid applies an increasing amount of torque to turbine 332. Turbine 332 is configured to rotate as the torque applied by the liquid reaches a selected amount.

Turbine 332 is operationally connected to a generator 337 in a substantially similar manner to turbine 132 and generator 134. Generator 337 is also similarly configured to connect to an external power system.

Hydroelectric generator 300 may be particularly suited to contexts including less than ideal flow rates. Specifically, by accumulating liquid within collecting bodies 334, hydroelectric generator 300 may drive hydroelectric turbines and/or generators in contexts where the flow from liquid input 312's would be otherwise insufficient to drive the turbine or generator.

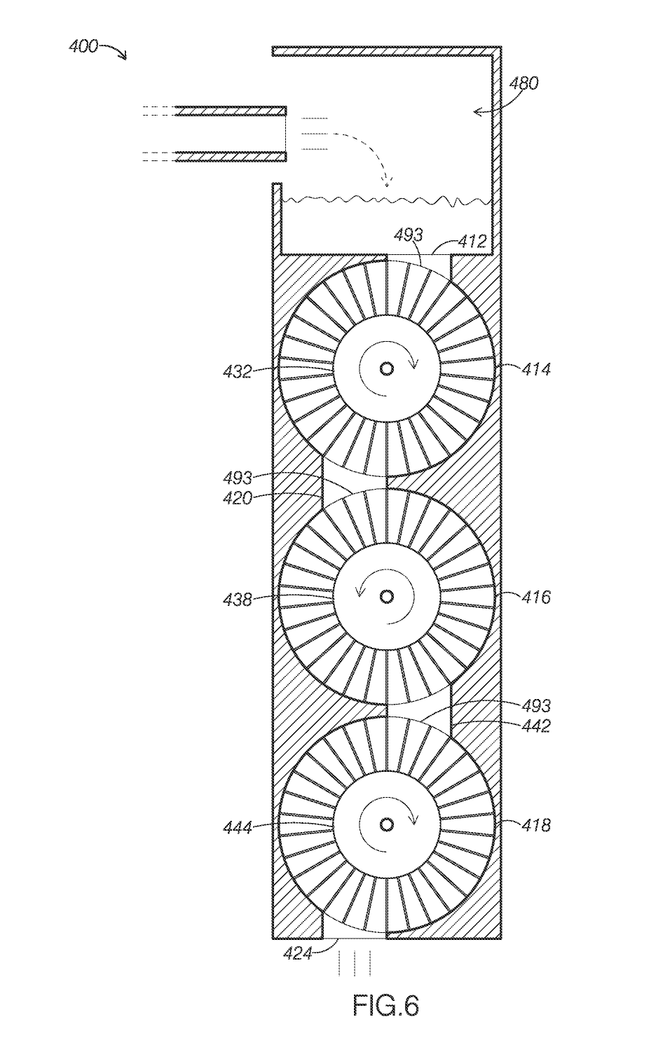

Turning attention to FIG. 6, a fourth example of a hydroelectric generator 400 will now be discussed. Hydroelectric generator 400 includes many similar or identical features to hydroelectric generator 300 combined in unique and distinct ways. Thus, for the sake of brevity, each feature of hydroelectric generator 400 will not be redundantly explained. Rather, key distinctions between hydroelectric generator 300 and hydroelectric generator 400 will be described in detail and the reader should reference the discussion above for features substantially similar between the two hydroelectric generators.

FIG. 6 shows that hydroelectric generator 400 is essentially a variation on hydroelectric generator 300 that includes three generators arranged in an alternating cascaded series. Specifically, hydroelectric generator 400 includes a generation unit 410 that defines a liquid input 412, a first turbine space 414, a second turbine space 416, a third turbine space 418, and a liquid output 424, each similar to the corresponding element of hydroelectric generator 300.

As shown in FIG. 6, generation unit 410 additionally defines a first channel 420 and a second channel 422. First channel 420 defines an opening between first turbine space 414 and second turbine space 416, and second channel 422 defines an opening between second turbine space 416 and third turbine space 418.

Hydroelectric generator 400 additionally includes a liquid collector 480 substantially similar to a liquid collector 380.

As can be seen in FIG. 6, hydroelectric generator 400 includes a first turbine 432, a second turbine 438, and a third turbine 444, each disposed at the corresponding turbine space and similar to turbine 332. Similar to turbine 332, each turbine defines a plurality of collection bodies 493 within the spaces between its blades, and is configured to drive a connected generator as collection bodies 493 collect liquid.

Generation unit 410 receives liquid from liquid input 412, routes the liquid through first turbine space 414, second turbine space 416, and third turbine space 418, and eventually sends the liquid out through liquid output 424. After the liquid has been used to drive first turbine 432 and second turbine 438, it flows through first channel 420 to second turbine space 416 and through second channel 422 to third turbine space 418.

As liquid flows in to first turbine space 414, second turbine space 416, and third turbine space 418, the liquid fills collection bodies of first turbine 432, second turbine 438, and third turbine 444, respectively, in a manner similar to hydroelectric generator 300. As discussed above, the liquid applies torque to the turbines as it fills the collection bodies.

Liquid flows through generation unit 410 to each turbine in the alternating fashion illustrated in FIG. 6. Specifically, in the orientation depicted in FIG. 6, liquid flows in to the right side of first turbine space 414, the left side of second turbine space 416, and the right side of third turbine space 418.

Additionally, the turbines are configured to rotate in opposite directions. Specifically, as hydroelectric generator 400 is viewed in FIG. 6, first turbine 432 is configured to rotate clockwise, second turbine 438 is configured to rotate counter-clockwise, and third turbine 444 is configured to rotate clockwise.

Hydroelectric generator 400 additionally provides efficiency gains through its alternating turbine design. Arranging the turbines in an alternating fashion allows the liquid to apply a torque to the turbines over a greater portion of the turbine spaces and provides less resistance as the liquid cascades from one turbine to a subsequent turbine.

Similar to hydroelectric generator 300, hydroelectric generator 400 generates potential energy by accumulating liquid within the collection bodies, which applies increasing torque on the turbines. As a result, hydroelectric generator 400 is able to generate a greater amount of torque with a low flow input than would result without storing the liquid within the collection bodies. Accordingly, hydroelectric generator 400 may drive hydroelectric turbines and/or generators in contexts where the flow input would be otherwise insufficient.

Hydroelectric generator 400 additionally provides efficiency gains by cascading liquid from a single source through a plurality of generators, similar to hydroelectric generator 200. Specifically, hydroelectric generator 400 extracts a greater amount of energy from the liquid and produces a greater amount of electricity than a single generator would prior to discarding the liquid.

Additionally, hydroelectric generator 400 is illustrated in FIG. 6 with precisely three turbines and generators. However, this is not specifically required, as the heart of the inventive subject matter lies more with including multiple cascaded turbines and generators arranged in an alternating manner. Accordingly, this disclosure specifically considers designs similar to hydroelectric generator 400 that include any number of plural cascading generators.

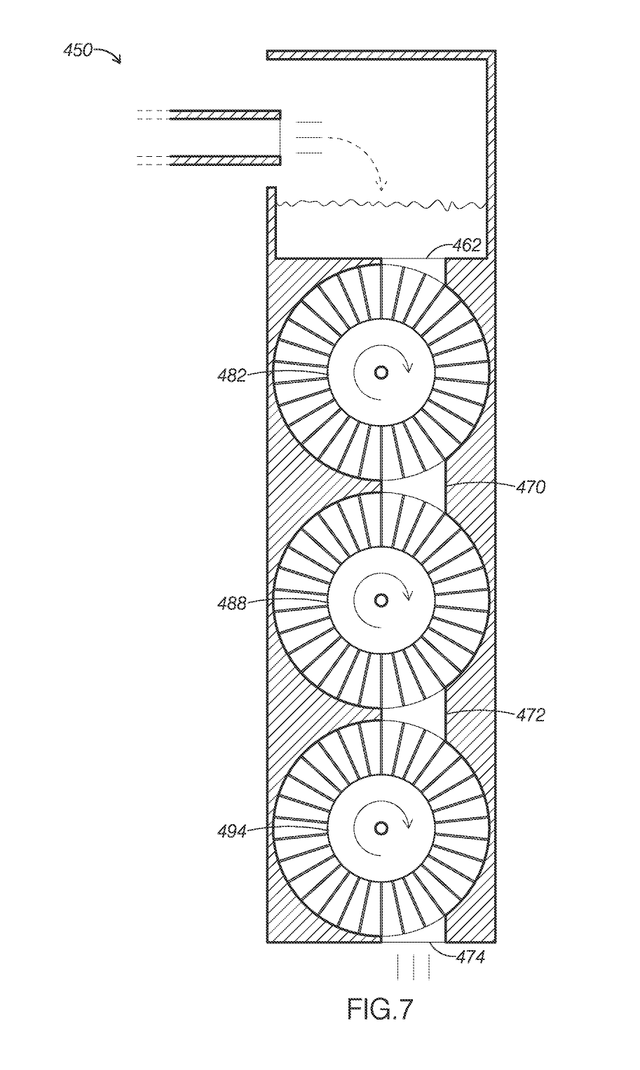

Turning attention to FIG. 7, a fifth example of a hydroelectric generator 450 will now be described. Hydroelectric generator 450 is substantially similar to hydroelectric generator 400, including a plurality of turbines organized vertically. Specifically, hydroelectric generator 450 includes a first turbine 482, a second turbine 488, and a third turbine 494. However, unlike hydroelectric generator 400's turbines, first turbine 482, second turbine 488, and third turbine 494 are configured to rotate in the same direction.

Additionally, hydroelectric generator 450 includes a liquid input 462, first channel 470, second channel 472, and liquid output 474, each of which is positioned substantially along the same side of a generation unit 460, rather than being positioned on alternate sides as one vertically traverses through the spaces between the turbines, as seen in hydroelectric generator 400.

Hydroelectric generator 450 primarily illustrates that, despite potential advantages of an alternating design, such a design is not specifically required.

Due to the similarity in their design, hydroelectric generator 300, hydroelectric generator 400, and hydroelectric generator 450 may substantially be used interchangeably. Additionally, “storage turbine hydroelectric generator” shall hereinafter refer to a class of hydroelectric generators that includes hydroelectric generator 300, hydroelectric generator 400, hydroelectric generator 450, and variations similar to each.

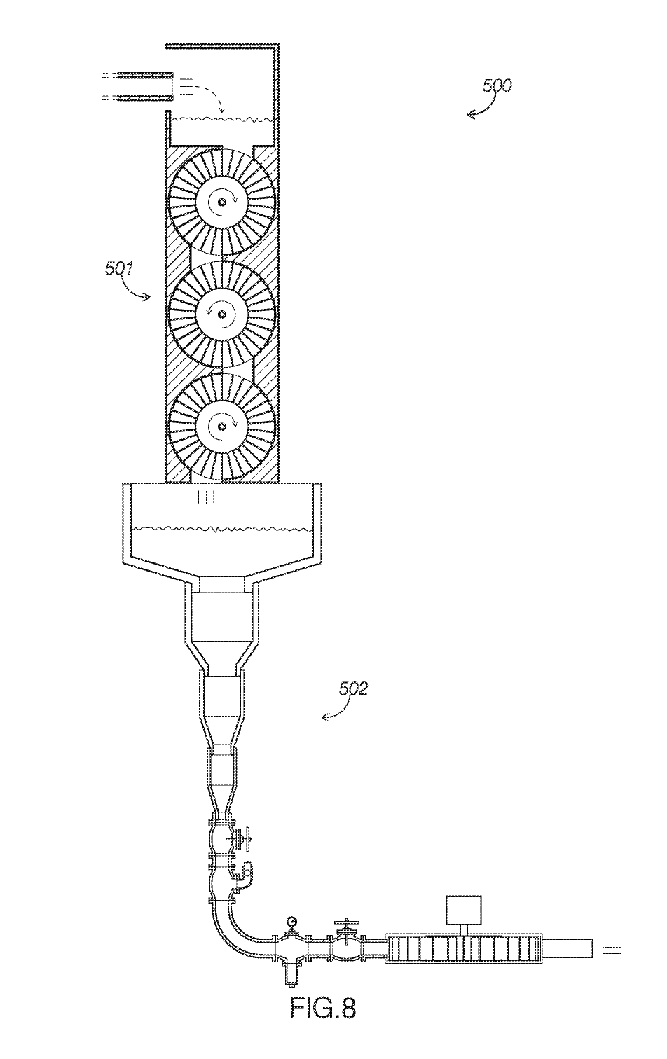

Turning attention to FIG. 8, a sixth example of a hydroelectric generator 500 will now be described. Hydroelectric generator 500 includes many similar or identical features to hydroelectric generator 200 and hydroelectric generator 400 combined in unique and distinct ways. Thus, for the sake of brevity, each feature of hydroelectric generator 500 will not be redundantly explained. Rather, key distinctions between hydroelectric generator 200, hydroelectric generator 400, and hydroelectric generator 500 will be described in detail and the reader should reference the discussion above for features substantially similar between the three hydroelectric generators.

Hydroelectric generator 500 implements a storage turbine hydraulic generator, specifically hydroelectric generator 400, as one of its cascaded units. Specifically, hydroelectric generator 500 includes a first cascaded unit 501 and a second cascaded unit 502 that interact in a substantially similar manner to the cascaded units of hydroelectric generator 200, wherein the output of first cascaded unit 501 serves as the input of second cascaded unit 502. Second cascaded unit 502 is substantially similar to the second cascaded unit of hydroelectric generator 200.

A primary difference between hydroelectric generator 500 and hydroelectric generator 200 lies in implementing a storage turbine hydroelectric generator as first cascaded unit 501, wherein hydroelectric generator 200 included a hydroelectric generator substantially similar to hydroelectric generator 100. Hydroelectric generator 500 illustrates the interchangeability of various disclosed hydroelectric generators when used in cascaded arrangements. As previously mentioned, specific cascaded elements in cascaded designs similar to hydroelectric generator 200 or hydroelectric generator 500 may take any form of hydroelectricity generator, whether specifically disclosed or not.

FIG. 8 additionally illustrates first cascaded unit 501 above the top of second cascaded unit 502. This arrangement substantially prevents the liquid collected in second cascaded unit 502 from impeding the output of first cascaded unit 501, thereby reducing the risk of flooding first cascaded unit 501.

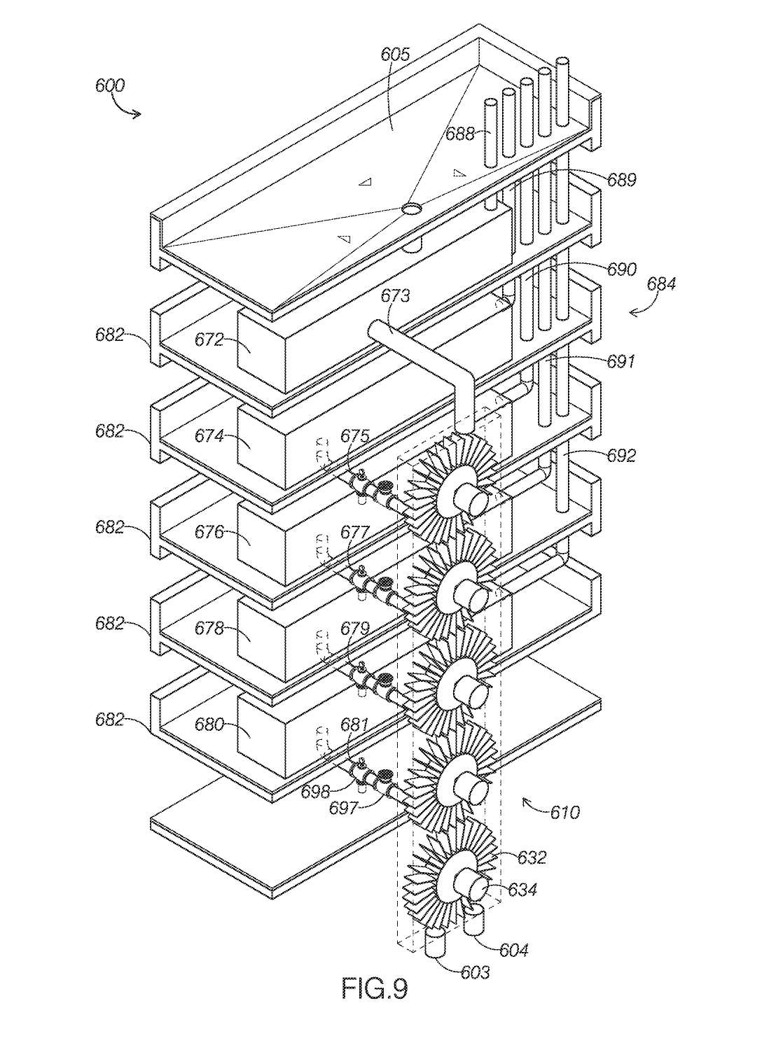

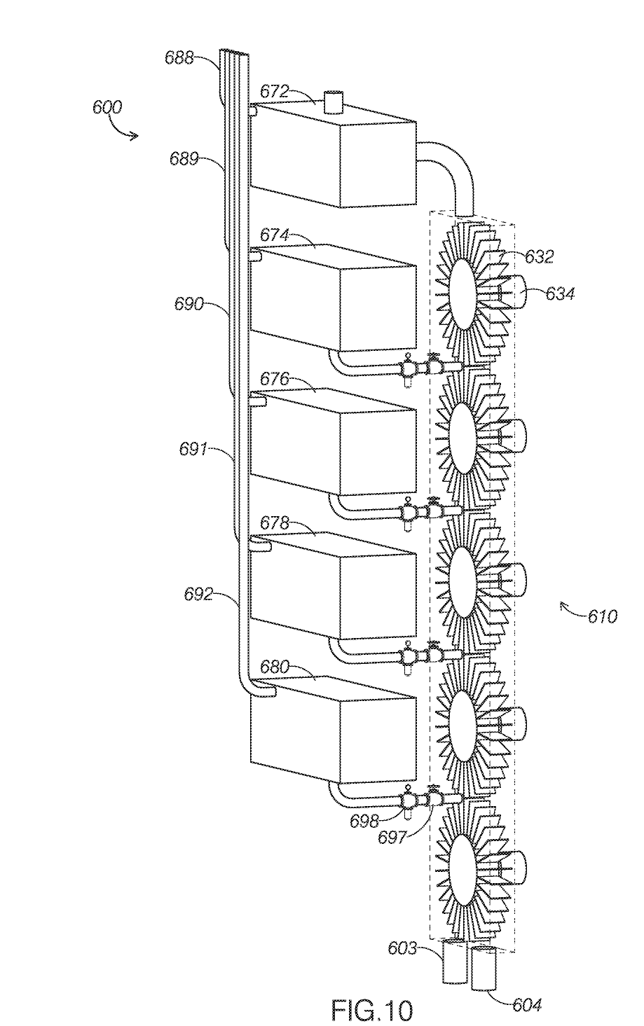

Turning attention to FIGS. 9 and 10, a seventh example of a hydroelectric generator 600 will now be described. Hydroelectric generator 600 shares many similar or identical features with previously disclosed examples of hydroelectric generators that are combined in unique and distinct ways. Thus, for the sake of brevity, each feature of hydroelectric generator 600 will not be redundantly explained. Rather, key distinctions between hydroelectric generator 600 and other previously disclosed example of hydroelectric generators will be described in detail and the reader should reference the discussion above for features substantially similar between the hydroelectric generators.

Hydroelectric generator 600 includes an environmental collection body 605, a generator system 610, and a collection of storage tanks: a first storage tank 672, a second storage tank 674, a third storage tank 676, a fourth storage tank 678, and a fifth storage tank 680. As illustrated in FIGS. 9 and 10, the storage tanks are vertically arranged, each located on a different floor 682 of a building 684.

Generator system 610 includes a vertically arranged collection of turbines 632, each turbine in the collection drivingly connected to a generator 634.

Generator system 610 additionally includes a first output 603 and a second output 604 positioned at the bottom of generator system 610. First output 603 and second output 604 are configured to route liquid from hydroelectric generator 600 to external waste disposal systems. First output 603 is configured to route the output of generator system 610, whereas second output 604 is configured to route liquid in a path that bypasses generator system 610, which may prevent hydroelectric generator 600 from flooding building 684. This specific dual output design is not specifically required, however. Single output designs and dual output designs wherein both outputs are connected to the generator system are equally within this disclosure.

Hydroelectric generator 600 additionally includes a collection of pipes, including: a first pipe 673, a second pipe 675, a third pipe 677, a fourth pipe 679, and a fifth pipe 681. Each pipe fluidly connects a corresponding storage tank to generator system 610. Specifically, first pipe 673 connects first storage tank 672 to generator system 610, second pipe 675 connects second storage tank 674 to generator system 610, third pipe 677 connects a third storage tank 676 to generator system 610, fourth pipe 679 connects fourth storage tank 678 to generator system 610, and fifth pipe 681 connects fifth storage tank 680 to generator system 610.

The storage tanks each include a gauge 698 configured to detect and display data corresponding to conditions inside the corresponding storage tank. For example, gauge 698 may display the volume of liquid in the corresponding storage tank and any gas or liquid pressure within the corresponding storage tank.

The pipes each include a valve 697 configured to allow a user to manipulate the level of liquid flow between the connected storage tank and generator system 610. Each valve 697 is substantially similar to valve 197 and controls the flow of liquid between the connected storage tank and generator system 610. The valves' operation in this manner allows hydroelectric generator 600 to operate safely and/or efficiently when the storage tanks contain varying levels of liquid.

Hydroelectric generator 600 also includes a collection body pipe 671 fluidly connecting collection body pipe 671 with first storage tank 672.

First storage tank 672, second storage tank 674, a third storage tank 676, fourth storage tank 678, and fifth storage tank 680 are each configured to fill via building 684's liquid waste disposal systems, including septic, sewage, gray water, and other means of disposing substantially liquid waste. Specifically, each storage tank is configured to collect the throughput of such systems from floors within building 684 at the same or higher elevation than the corresponding storage tank, harnessing gravity to maximize the efficiency of the storage of the liquid waste.

Additionally, environmental collection body 605 is configured to collect liquid from environmental sources, including stormwater, and direct this collected liquid to first storage tank 672.

Hydroelectric generator 600 additionally includes a first vent 688, a second vent 689, a third vent 690, a fourth vent 691, and a fifth vent 692. Each vent is connected on a first end to its corresponding storage tank, and includes an opposite end routed out of the top of building 684 on the opposite end. The vents are configured to release pressure from the storage tanks, substantially reducing the risk of implosion to the corresponding storage tank or to hydroelectric generator 600 overall.

FIG. 10 illustrates a detailed view of a solid waste mixer 699 included within second storage tank 674, a third storage tank 676, fourth storage tank 678, and fifth storage tank 680. Each solid waste mixer 699 includes a storage tank turbine 693, a storage tank gear 685, and metal bodies 686 positioned within the interior of each tank.

As liquid enters solid waste mixer 699, the liquid cascades over storage tank turbine 693, which is drivingly connected to storage tank gear 685. Metal bodies 686 are drivingly connected to storage tank gear 685 and substantially extend within the volume of the storage tank. As liquid cascades over storage tank turbine 693, metal bodies 686 are configured to rotate around the interior of the storage tank and substantially reduce the size of bodies of solid waste contained therein.

This disclosure specifically contemplates embodiments in which multiple storage tank mixers are positioned within one or more storage tanks. As a specific example, the storage tank may include a collection of mixers whose areas of operation overlap, similar to the operation seen in a dual-element electronic hand mixer.

Hydroelectric generator 600 is configured to accumulate liquid in the storage tanks, collected from the various disclosed sources, and thereby accumulate potential energy in the liquid body contained within the storage tanks. Upon collecting a selected amount of liquid and potential energy, hydroelectric generator 600 is configured to communicate the contents of the liquid body to generator system 610. As the liquid cascades through generator system 610, the liquid applies torque to turbines 632 that are drivingly connected to generators 634. Generators 634 are electrically connected to external electrical distribution networks, which may include the electrical network distributing power to building 684.

Hydroelectric generator 600 provides efficiency gains through harnessing a liquid source that is otherwise underutilized. Additionally, it provides efficiency gains through by including a mechanism powered by the liquid source itself to break up solid waste contained within the liquid source. Hydroelectric generator 600 also provides efficiency gains by storing liquid waste within the storage tanks to accumulate potential energy when the flow would otherwise be insufficient to power a hydroelectric generator.

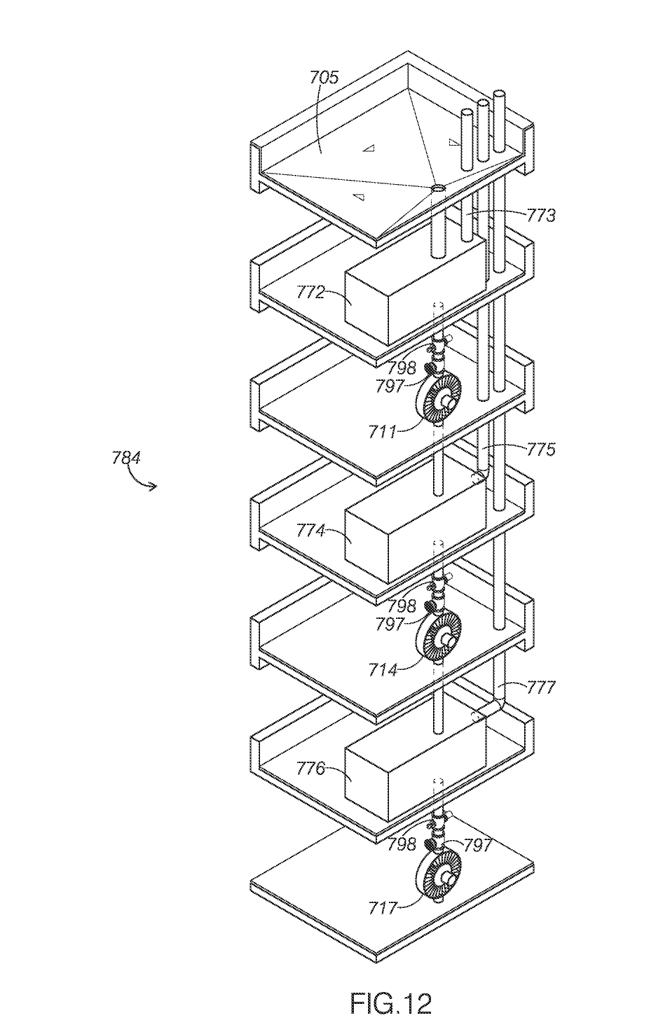

Turning attention to FIG. 12, an eighth example of a hydroelectric generator, hydroelectric generator 700, will now be described. Hydroelectric generator 700 shares many similar or identical features with hydroelectric generator 600 that are combined in unique and distinct ways. Thus, for the sake of brevity, each feature of hydroelectric generator 700 will not be redundantly explained. Rather, key distinctions between hydroelectric generator 700 and other previously disclosed examples of hydroelectric generators will be described in detail and the reader should reference the discussion above for features substantially similar between the hydroelectric generators.

As FIG. 12 illustrates, hydroelectric generator 700 includes a first storage tank 772, a second storage tank 774, and a third storage tank 776 positioned on alternating floors of a building 784. The storage tanks are configured to accumulate liquid from the liquid waste disposal systems of building 784 similar the storage tanks of hydroelectric generator 600. Hydroelectric generator 700 additionally includes an environmental collection body 705 similar to environmental collection body 605 and is similarly connected to first storage tank 672.

Additionally, the storage tanks are substantially similar to the storage tanks of hydroelectric generator 600. Specifically, each storage tank includes internal components similar to storage tank gear 685 and metal bodies 686 illustrated in FIG. 10.

The storage tanks are attached to vents to release pressure within the elements of hydroelectric generator 700 and to prevent implosion of the storage tanks and other connected elements. Specifically, first storage tank 772 is connected to first vent 773, second storage tank 774 is connected to second vent 775, and third storage tank 776 is connected to third vent 777, each vent being connected to the storage tank at one end and routed through the roof of building 784 on the opposite end.

Unlike the design of hydroelectric generator 600, in which each of the storage tanks is in fluid communication with a single generator system 610, each storage tank included in hydroelectric generator 700 is in fluid communication with a generation unit positioned on the adjacent floor of building 784 below the corresponding storage tank. Specifically, first storage tank 772 is in fluid communication with first generation unit 711, second storage tank 774 is in fluid communication with second generation unit 714, and third storage tank 776 is in fluid communication with third generation unit 717.

Additionally, the generation units are configured to output liquid to the storage tank on the floor of building 784 below the corresponding generation unit. Specifically, first generation unit 711 outputs to second storage tank 774 and second generation unit 714 outputs to third storage tank 776. Third generation unit 717 is configured to output liquid to an external liquid waste disposal means, specifically including sewage lines or storm water drainage systems.

Additionally, the pipes connecting each storage tank to the adjacently downstream generator includes a valve 797 and gauge 798, similar in operation to the valves and gauges described in relation to hydroelectric generator 600. Similar to the valves and gauges in hydroelectric generator 600, these valves and gauges are configured to allow greater control of pressure and/or the amount of stored liquid and may be configured for manual or automatic operation.

Though not illustrated, hydroelectric generators similarly designed to hydroelectric generator 700 may be configured with a pipe or collection of pipes that route the liquid contained in the storage tanks directly into wastewater disposal means. This allows hydroelectric generator 700 to safely dispose of excess liquid within the storage tanks in high flow contexts.

As liquid accumulates in each storage tank, hydroelectric generator 700 accumulates potential energy, similar to hydroelectric generator 600. Upon reaching a selected amount of potential energy, a storage tank communicates the liquid to the connected generation unit on the floor adjacently below the storage tank. The generation units of hydroelectric generator 700 are substantially similar to generation unit 110, and are likewise connected to an external electrical distribution system for usage and/or storage. This disclosure specifically contemplates using this energy within building 784 and/or distributing the generated energy to power systems substantially external to building 784.

FIG. 12 illustrates one potential design of hydroelectric generator 700 where the connections between storage tanks and generation units are relatively short segments of pipe. In many designs, the length of these connections may be considerably longer relative the other units, and may in some cases extend several hundred feet. This disclosure specifically contemplates designs including connections between storage tanks and generation units that extend any length.

Although hydroelectric generator 700 illustrated in FIG. 12 includes generators similar to generation unit 110, this is not specifically required. Hydroelectric generators similar to hydroelectric generator 700 may include any disclosed type of generator unit or system, specifically including storage turbine hydroelectric generators.

Both hydroelectric generator 600 and hydroelectric generator 700 are generally illustrative of hydroelectric generators situated within a building. Although these particular examples are illustrated with a specific number of floors, this disclosure specifically contemplates the general concepts embodied by these designs to be applied to buildings of any number of floors. Specifically, this disclosure contemplates any design accumulating a potential energy in a liquid body by storing various forms of substantially liquid waste from a building into a storage tank or a plurality of storage tanks located within the building and outputting this liquid containing the potential energy to a hydroelectric generator or a plurality thereof.

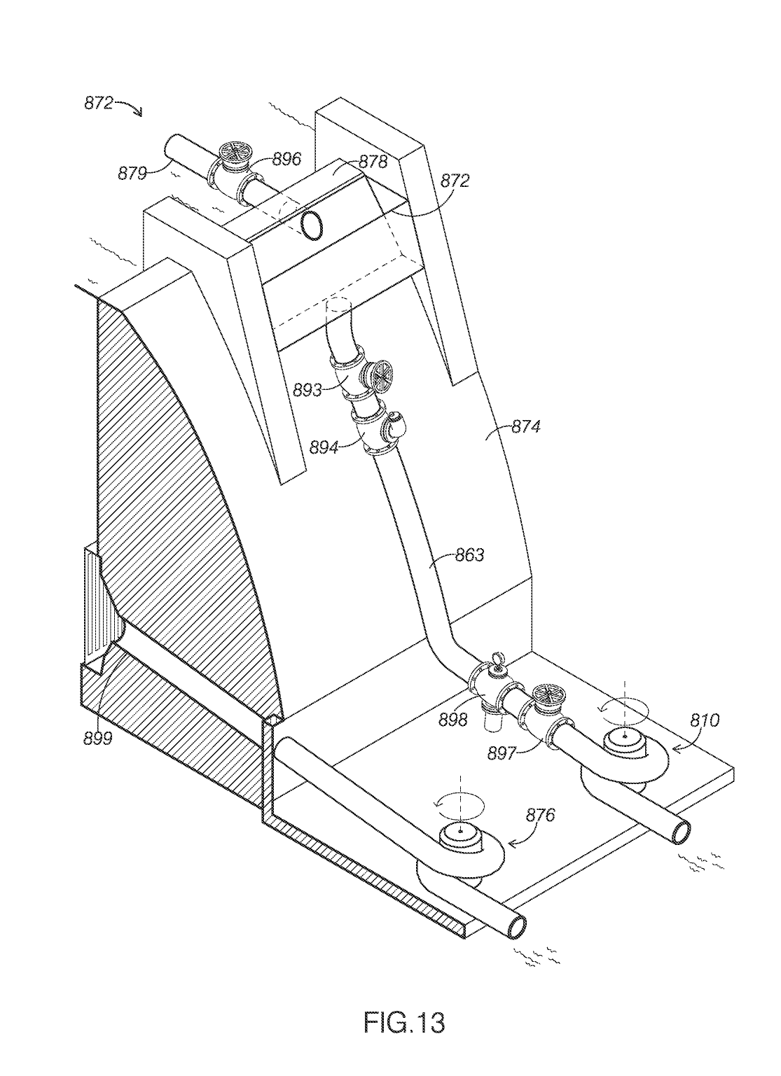

Turning attention to FIG. 13, an ninth example of a hydroelectric generator, hydroelectric generator 800, will now be described. Hydroelectric generator 800 shares many similar or identical features with previously disclosed examples of hydroelectric generators that are combined in unique and distinct ways. Thus, for the sake of brevity, each feature of hydroelectric generator 800 will not be redundantly explained. Rather, key distinctions between hydroelectric generator 800 and other previously disclosed examples of hydroelectric generators will be described in detail and the reader should reference the discussion above for features substantially similar between the hydroelectric generators.

Turning attention to FIG. 13, an ninth example of a hydroelectric generator, hydroelectric generator 800, will now be described. Hydroelectric generator 800 shares many similar or identical features with previously disclosed examples of hydroelectric generators that are combined in unique and distinct ways. Thus, for the sake of brevity, each feature of hydroelectric generator 800 will not be redundantly explained. Rather, key distinctions between hydroelectric generator 800 and other previously disclosed examples of hydroelectric generators will be described in detail and the reader should reference the discussion above for features substantially similar between the hydroelectric generators.

FIG. 13 illustrates hydroelectric generator 800 connected to a dam 874 impeding a liquid source 872. As FIG. 13 illustrates, hydroelectric generator 800 includes a top spillway 878, a spillway pipe 879, a spillway collecting body 872, a generation unit 810, and a pipe 863.

Dam 874 additionally includes a dam hydroelectric generator 876 that uses the potential energy contained in liquid source 872 flowing through a penstock 899. Dam hydroelectric generator 876 is configured to generate electrical energy independent of hydroelectric generator 800.

Hydroelectric generator 800 includes a top spillway 878 routed over a selected segment of the top of dam 874. Top spillway 878 is configured to direct a portion of liquid source 872 when the surface level of liquid source 872 rises above the top of dam 874. Hydroelectric generator 800 additionally includes a spillway pipe 879 connected directly to liquid source 872 on a first end and to spillway collecting body 872 on the opposite end. Spillway pipe 879 includes a spillway valve 896 proximate liquid source 872.

Top spillway 878 and spillway pipe 879 are collectively configured to direct a portion of liquid source 872 over and/or around dam 874 if it contains a selected amount of excess liquid. Top spillway 878 and spillway pipe 879 are additionally configured to route a certain amount of the excess liquid to spillway collecting body 872. Spillway pipe 879 is specifically configured to selectively communicate liquid from liquid source 872 through opening and closing spillway valve 896.

Hydroelectric generator 800 is configured similar to hydroelectric generator 100, wherein spillway collecting body 872 is configured to collect liquid flowing over top spillway 878 and through spillway pipe 879 in a similar manner to how collection body 160 is configured to collect a liquid from liquid source 106. As liquid is collected in spillway collecting body 872, it is funneled and directed to generation unit 810 via pipe 863.

Pipe 863 includes a valve 897 and gauge 898 positioned proximate generation unit 810. Gauge 898, similar to gauge 198, is configured to detect and display the current amount of pressure accumulated within pipe 863. Valve 897 is configured to release excess pressure from pipe 863 by opening to release excess gas or liquid contained therein, which may substantially prevent damage to hydroelectric generator 800 resulting from an excess of liquid or gas pressure. Additionally, valve 897 substantially ensures that liquid flows through generation unit 810 at a selected rate of flow. Valve 897 and gauge 898, similar to valve 197 and gauge 198, may be configured for either manual or automatic operation.

Hydroelectric generator 800 additionally includes an upstream valve 893 and an upstream air release valve 894. Upstream valve 893 is substantially similar to second valve 199, and upstream air release valve 894 is substantially similar to air release valve 196.

Prior to communicating the liquid contained within spillway collecting body 872 and pipe 863 to generation unit 810, hydroelectric generator 800 accumulates potential energy similar to hydroelectric generator 100. Specifically, hydroelectric generator 800 accumulates potential energy by establishing a head of liquid prior to communicating the liquid to generation unit 810.

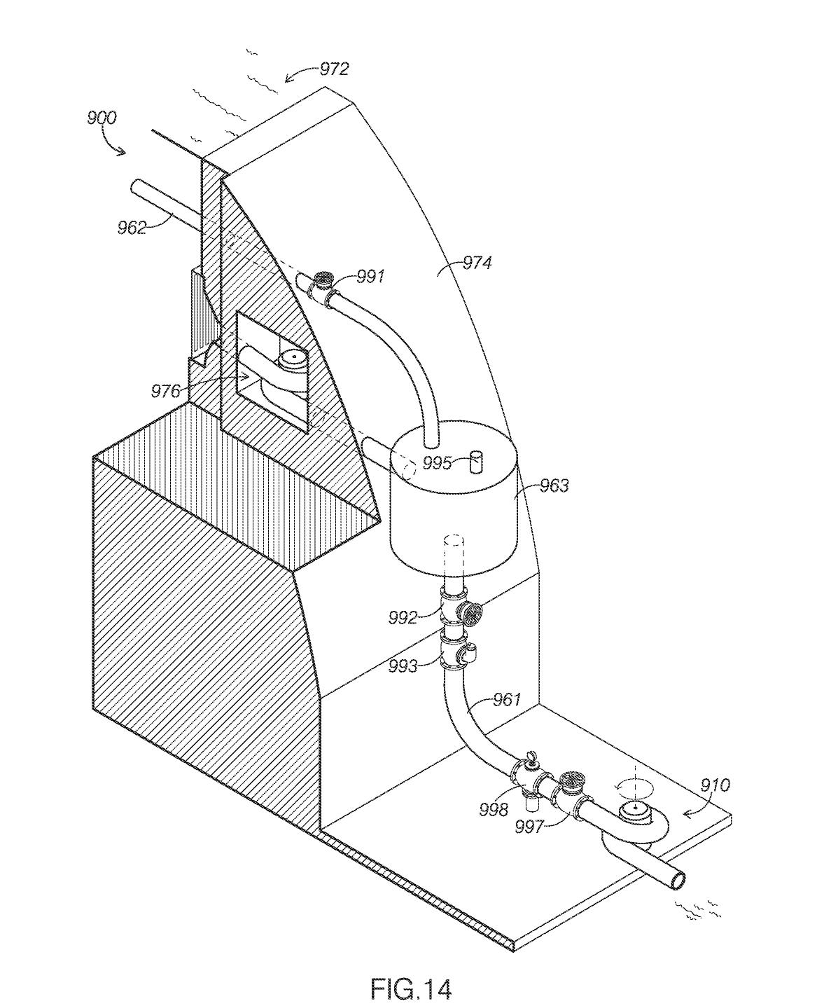

Turning attention to FIG. 14, a tenth example of a hydroelectric generator, hydroelectric generator 900, will now be described. Hydroelectric generator 900 shares many similar or identical features with previously disclosed examples of hydroelectric generators that are combined in unique and distinct ways. Thus, for the sake of brevity, each feature of hydroelectric generator 900 will not be redundantly explained. Rather, key distinctions between hydroelectric generator 900 and other previously disclosed examples of hydroelectric generators will be described in detail and the reader should reference the discussion above for features substantially similar between the hydroelectric generators.

As FIG. 14 illustrates, hydroelectric generator 900 is connected to a dam 974 impeding a liquid source 972 that produces a current. The dam includes a dam interior hydroelectric generator 976 that uses the potential energy contained in liquid source 972 to generate electrical energy.

Hydroelectric generator 900 includes a spillway channel 962 substantially routed through dam 974. Hydroelectric generator 900 includes a collection body 963 connected to and configured to collect the output of spillway channel 962 and the output of dam interior hydroelectric generator 976. Hydroelectric generator 900 additionally includes a head pipe 961 connected to collection body 963 on a first end and to a generation unit 910 on the opposite end.

Similar to hydroelectric generator 800, hydroelectric generator 900 includes a spillway valve 991 that selectively communicates liquid from liquid source 972 through spillway channel 962.

As FIG. 14 shows, hydroelectric generator 900 is substantially similar to hydroelectric generator 800. A primary difference between hydroelectric generator 900 and hydroelectric generator 800 lies in how it collects the output of dam interior hydroelectric generator 976 and sends it to generation unit 910 in addition to spillway channel 962. After liquid is collected within collection body 963, the collected liquid is distributed to generation unit 910 in a manner substantially similar to hydroelectric generator 800. Additionally, generation unit 910 functions substantially similar to generation unit 810.

Hydroelectric generator 900 additionally includes a valve 997 and a gauge 998 positioned at a position on head pipe 961 upstream of generation unit 910. Valve 997 and gauge 998 regulate the liquid flow and pressure within head pipe 961 and generation unit 910 in a manner substantially similar to valve 197 and gauge 198.

Head pipe 961 additionally includes a head pipe valve 992, an air release valve 993, and a pressure release opening 995. Head pipe valve 992 is configured to open and close, allowing the selective distribution of liquid through head pipe 961. Release pipe 964 is configured to release any excess pressure contained within collection body 963 as it collects liquid. Air release valve 993 is substantially similar to air release valve 196.

As the surface of liquid source 972 rises to a selected level, excess liquid is routed through spillway channel 962. As the liquid passes through spillway channel 962, it accumulates potential energy within head pipe 961, substantially similar to hydroelectric generator 800 and/or hydroelectric generator 100. Upon generating a sufficient amount of potential energy, the liquid is then routed through a generation unit 910, which operates substantially similar to generation unit 110.

Additionally, hydroelectric generator 900 includes a mechanism similar to the one illustrated in FIG. 10 for breaking up solid materials within head pipe 961. The mechanism in hydroelectric generator 900 is substantially similar to storage tank gear 685 and metal bodies 686 described above. Including such a mechanism for breaking up solid waste within head pipe 961 illustrates that the mechanism is not limited to hydroelectric generator 600 and hydroelectric generator 900, and it may may included in a similar manner within other hydraulic generators.

In particular, implementing systems such as that seen in FIG. 10 may be particularly useful for breaking up solid waste in hydroelectric generators including a storage tank similar to storage tank 161, particularly in sewage disposal systems. Additionally, such systems may be implemented in systems including dams similar to darn 974, particularly in systems in which the liquid is routed from a spillway to similarly break up bodies that may be contained within a natural liquid source such as a river.

Hydroelectric generator 800 and hydroelectric generator 900 are designed to augment electrical energy generation in hydroelectric dam contexts by harnessing potential energy within a spillway that would otherwise be wasted. As a result, this disclosure contemplates using hydroelectric generators downstream of a hydroelectric dam spillway to harness this energy, specifically including, but not limited, to those presently disclosed.

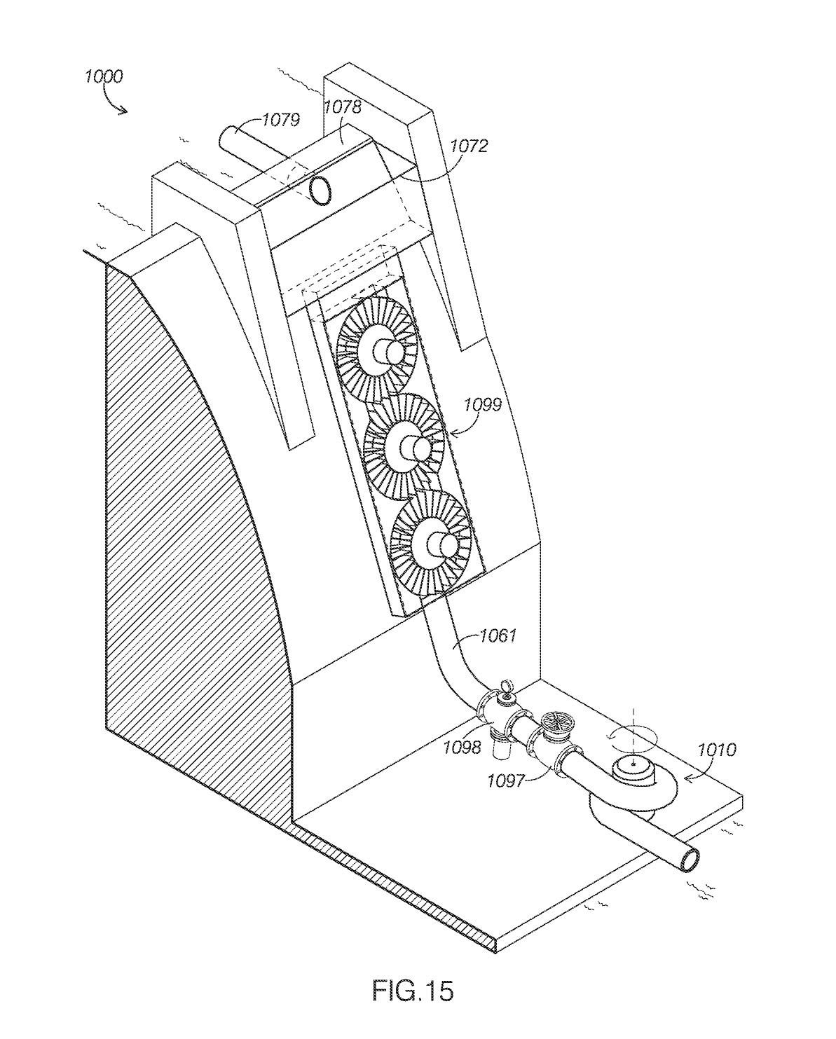

Turning attention to FIG. 15, an eleventh example of a hydroelectric generator, hydroelectric generator 1000, will now be described. Hydroelectric generator 1000 shares many similar or identical features with previously disclosed examples of hydroelectric generators that are combined in unique and distinct ways. Thus, for the sake of brevity, each feature of hydroelectric generator 1000 will not be redundantly explained. Rather, key distinctions between hydroelectric generator 1000 and other previously disclosed examples of hydroelectric generators will be described in detail and the reader should reference the discussion above for features substantially similar between the hydroelectric generators.

As FIG. 15 illustrates, hydroelectric generator 1000 includes a dam 1074 impeding a liquid source 1072. Hydroelectric generator 1000 includes a spillway pipe 1079, a top spillway 1078, and a spill-way collection body 1072, each substantially similar in design and function to the corresponding elements of hydroelectric generator 800.

Hydroelectric generator 1000 includes a storage turbine hydroelectric generator 1099 in fluid communication with spillway collection body 1072. Hydroelectric generator 1000 additionally includes a head pipe 1061 connected to the output of storage turbine hydroelectric generator 1099 on a first end and to a generation unit 1010 on the opposite end.

Hydroelectric generator 1000 includes a valve 1097 and a gauge 1098 positioned on head pipe 1061 upstream of generation unit 1010. Valve 1097 and gauge 1098 operate to regulate the liquid flow and pressure within head pipe 1061 and generation unit 1010 in a manner substantially similar to valve 197 and gauge 198.

Hydroelectric generator 1000 is configured to operate substantially similar to hydroelectric generator 800. However, hydroelectric generator 1000 further harnesses the potential energy contained with the liquid by powering the generators contained within storage turbine hydroelectric generator 1099 prior to communicating the liquid stored in spillway collection body 1072 to head pipe 1061.

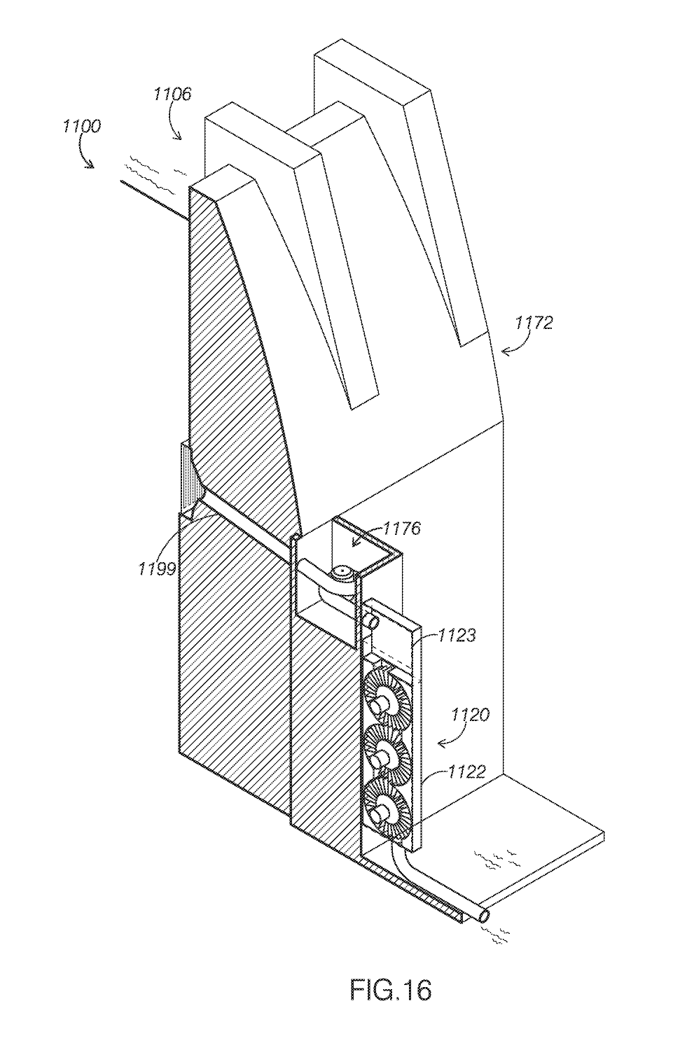

Turning attention to FIG. 16, a twelfth example of a hydroelectric generator, hydroelectric generator 1100, will now be discussed. Hydroelectric generator 1100 shares many similar or identical features with previously disclosed examples of hydroelectric generators that are combined in unique and distinct ways. Thus, for the sake of brevity, each feature of hydroelectric generator 1100 will not be redundantly explained. Rather, key distinctions between hydroelectric generator 1100 and other previously disclosed examples of hydroelectric generators will be described in detail and the reader should reference the discussion above for features substantially similar between the hydroelectric generators.

Hydroelectric generator 1100 includes a dam 1172 and a downstream generation system 1120. Hydroelectric generator 1100 is generally configured to route the output of a hydroelectric generator within a dam to a storage turbine hydroelectric generator.

Dam 1172 includes a penstock 1199 and dam generator 1176. Dam 1172 is configured to impede a liquid source 1106 and to substantially accumulate a potential energy within liquid source 1106.

Penstock 1199 is configured to communicate liquid from liquid source 1106 to dam generator 1176. Dam generator 1176 is configured to generate electricity through via the communicated liquid, substantially similar to generation unit 110.

Downstream generation system 1120 is configured to collect the output of dam generator 1176 and to route it through a storage turbine hydroelectric generator 1122. This arrangement allows greater efficiency over a typical hydroelectric dam design by using the output of dam generator 1176 to power a downstream generator. Additionally, implementing storage turbine hydroelectric generator 1122, which includes collection area 1123 allows liquid to be collected for downstream generation without impeding the flow of liquid through dam generator 1176.

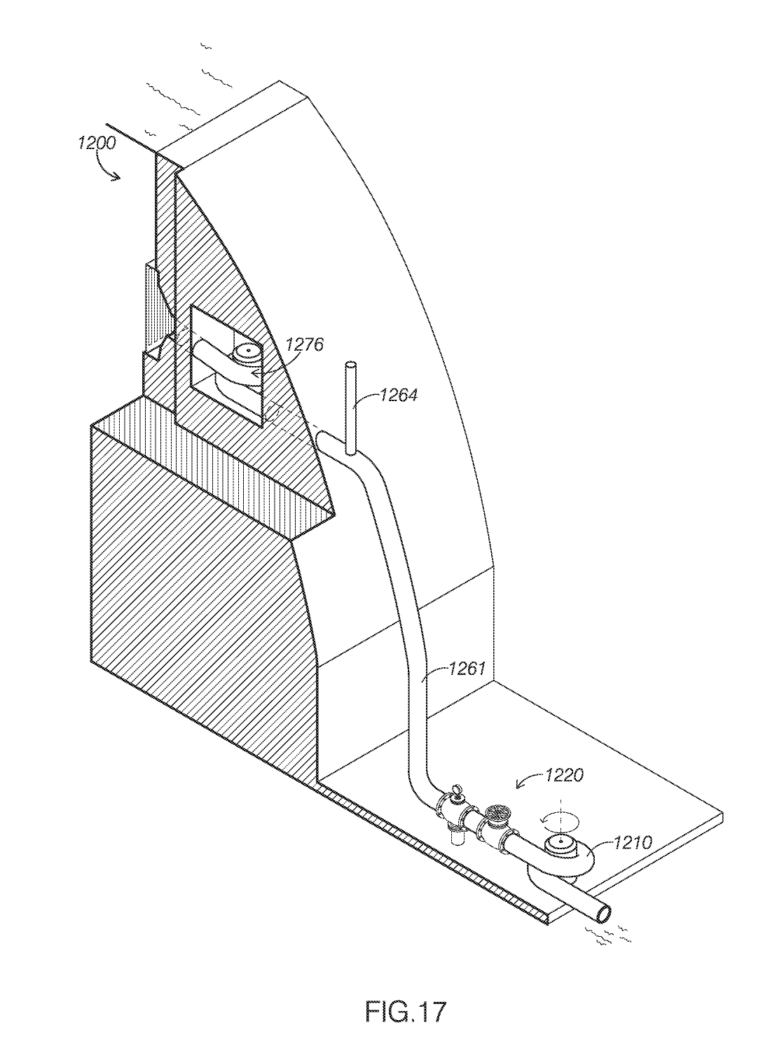

Turning attention to FIG. 17, a thirteenth example of a hydroelectric generator, hydroelectric generator 1200, will now be discussed. Hydroelectric generator 1200 shares many similar or identical features with previously disclosed examples of hydroelectric generators that are combined in unique and distinct ways. Thus, for the sake of brevity, each feature of hydroelectric generator 1200 will not be redundantly explained. Rather, key distinctions between hydroelectric generator 1200 and other previously disclosed examples of hydroelectric generators will be described in detail and the reader should reference the discussion above for features substantially similar between the hydroelectric generators.

Hydroelectric generator 1200 is substantially similar to hydroelectric generator 1100, as it implements a dam generator 1276 in fluid communication with a downstream generation system 1220. However, unlike downstream generation system 1120, downstream generation system 1220 is not a storage turbine hydroelectric generator. Instead, downstream generation system 1220 includes a head pipe 1261 and a generation unit 1210 that operate substantially similar to head pipe 163 and generation unit 110.

Hydroelectric generator 1200 additionally includes a release pipe 1264 due to the potential for pressure to accumulate within head pipe 1261 without adequate means for release due to dam generator 1276 being positioned upstream. Release pipe 1264 is configured to release such accumulated pressure in a substantially safe manner.

Though release pipe 1264 is discussed specifically in connection with hydroelectric generator 1200, the use of release pipes in general is not limited to hydroelectric generators similar to hydroelectric generator 1200. Release pipes may be implemented in any of the disclosed hydroelectric generators. Release pipes that are connected and controlled by valves and/or gauges are both within this disclosure. As a specific example, hydroelectric generator 900 includes a release pipe 964 positioned on collection body 963.

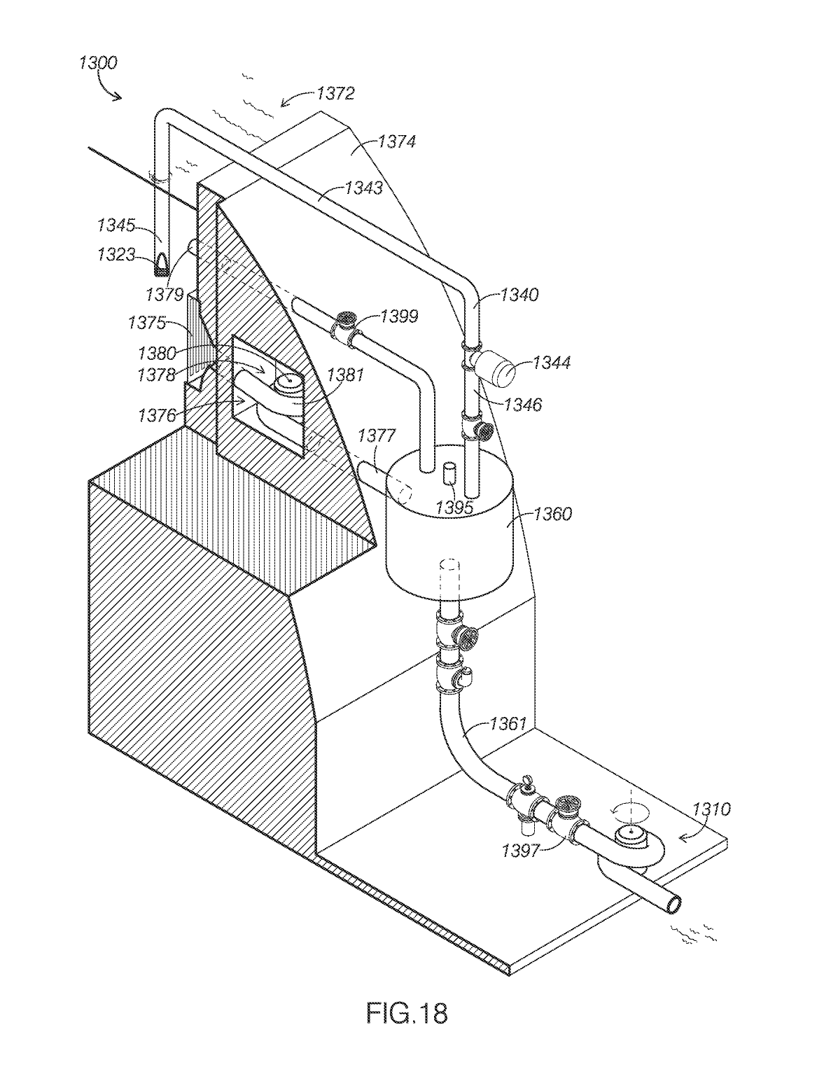

Turning attention to FIG. 18, a fourteenth example of a hydroelectric generator, hydroelectric generator 1300, will now be discussed. Hydroelectric generator 1300 shares many similar or identical features with previously disclosed examples of hydroelectric generators that are combined in unique and distinct ways. Thus, for the sake of brevity, each feature of hydroelectric generator 1300 will not be redundantly explained. Rather, key distinctions between hydroelectric generator 1300 and other previously disclosed examples of hydroelectric generators will be described in detail and the reader should reference the discussion above for features substantially similar between the hydroelectric generators.

As illustrated in FIG. 18, hydroelectric generator 1300 includes a liquid source 1372, a dam 1374, a spillway pipe 1379, a siphon 1340, a collection body 1360, and a generation unit 1310. Hydroelectric generator 1300, similar to other disclosed hydroelectric generators, is configured to generate electricity by harnessing potential energy from a volume of liquid contained in liquid source 1372 by communicating the liquid to a generation unit 1310 at a lower position. Hydroelectric generator 1300, similar to hydroelectric generator 900, is configured to harness the output of a hydroelectric generator within dam 1374 and from spillway pipe 1379. However, unlike previously disclosed hydroelectric generators, hydroelectric generator 1300 routes the liquid through a relatively higher elevation region defined by siphon 1340 prior to communicating the liquid to generation unit 1310.

As FIG. 18 illustrates, liquid source 1372 defines a volume of liquid representing a source of potential energy due to its higher elevation than generation unit 1310. Liquid source 1372 is not required to contain a specific volume of liquid; rather, hydroelectric generator 1300 is configured to harness the potential energy of liquid contained within liquid source 1372 at various volumes by receiving the liquid via dam 1374, spillway pipe 1379, and/or siphon 1340, acting individually or in concert.

As seen in FIG. 18, dam 1374 is adjacent to liquid source 1372. Dam 1374 includes a dam generator 1376. Dam 1374 impedes liquid source 1372 and collects to a selected volume of liquid. Upon reaching a sufficient volume, dam 1374 is configured to feed a selected quantity of the liquid contained within liquid source 1372 through dam generator 1376 to generate electricity.

Dam generator 1376 is a hydroelectric generator positioned within dam 1374. Dam generator 1376 includes a penstock 1375, a dam generation unit 1378, and a internal generator output pipe 1377. Dam generator 1376 is configured to receive liquid from liquid source 1372, feed the liquid through dam generator 1376 to drive dam generation unit 1378 and to generate electricity, and output the liquid to collection body 1360.

Dam generation unit 1378 includes a turbine 1381 and a generator 1380. Dam generator 1376 is configured to feed liquid through dam generation unit 1378 to drive turbine 1381, which is drivingly connected to generator 1380. Penstock 1375 defines a channel between liquid source 1372 and dam generation unit 1378, allowing liquid source 1372 to feed and drive dam generation unit 1378. Penstock 1375 is configured to receive liquid from liquid source 1372 and communicate the liquid to dam generation unit 1378 when liquid source 1372 contains a volume of liquid above a selected minimum volume sufficient to drive dam generation unit 1378.

Internal generator output pipe 1377 is connected on a first end to the output of dam generator 1376 on a first end and to collection body 1360 on a second end. Working in concert, penstock 1375, dam generation unit 1378, and collection body 1360 cooperatively feed liquid through dam generator 1376 to generate electricity and output the liquid to collection body 1360 where it may later be harnessed by generation unit 1310.

Spillway pipe 1379 extends from a first end within liquid source 1372 to a second end connected to collection body 1360. Spillway pipe 1379 includes a spillway valve 1399 positioned proximate its second end. Spillway pipe 1379 is configured to selectively direct liquid from liquid source 1372 to collection body 1360. By selectively directing liquid away from liquid source 1372, spillway pipe 1379 may be used to substantially limit the volume of the liquid contained within liquid source 1372 and prevent flooding.

Specifically, spillway pipe 1379 is configured to selectively route liquid from liquid source 1372 to collection body 1360 when the volume of liquid contained in liquid source 1372 exceeds a selected volume, which may substantially prevent flooding in the area surrounding hydroelectric generator 1300. Spillway pipe 1379 may be configured for automatic operation when the volume of liquid source 1372 exceeds the selected value, but may also be configured to be operated manually. Additionally or alternatively, spillway pipe 1379 may receive liquid from liquid source 1372 when liquid source 1372 contains a volume sufficient to reach spillway pipe 1379. Similar to spillway channel 962, spillway pipe 1379 outputs to collection body 1360 so the output liquid may be harnessed for hydroelectric generation by generation unit 1310.

Spillway valve 1399 is positioned proximate the second end of spillway pipe 1379. Spillway valve 1399 is configured to selectively open to allow liquid to flow from liquid source 1372 through spillway pipe 1379, thereby allowing a user to substantially regulate the volume of liquid source 1372.

As FIG. 18 illustrates, siphon 1340 extends from a first end located within liquid source 1372 to a second end connected to collection body 1360. Siphon 1340 includes a siphon pipe 1342, a primer pump 1344, and a siphon valve 1347. Siphon 1340 is configured to selectively route liquid from liquid source 1372 to collection body 1360, where it may be further harnessed by generation unit 1310.

Siphon pipe 1342 defines a pipe extending over dam 1374 from a first end located within liquid source 1372 to a second end connected to collection body 1360 at a lower elevation than the first end. Siphon pipe 1342 includes an elevated segment 1343 that is higher than both the first end and the second end in elevation. Siphon pipe 1342 includes an input segment 1345 that extends from the first end to elevated segment 1343 and a discharge segment 1346 that extends from elevated segment 1343 to the second end.

Siphon pipe 1342 is configured to receive liquid from liquid source 1372 when there is a sufficient volume of liquid within liquid source 1372 to power dam generator 1376 and also when the volume is insufficient. When there is not a sufficient volume of liquid within liquid source 1372 to power dam generator 1376, the first end of siphon pipe 1342 may be positioned above or below penstock 1375.

Siphon pipe 1342 is configured to move liquid contained within liquid source 1372 to collection body 1360 without requiring external means, such as a pump. Specifically, liquid contained within discharge segment 1346 is discharged into collection body 1360 when the hydrostatic pressure at the inlet of siphon pipe 1342 is greater than the pressure of the outlet of siphon pipe 1342.

Siphon pipe 1342 additionally includes screen 1323 positioned on the first end of the siphon pipe. Screen 1323 defines a perforated metal plate including perforations conforming to NOAA standards to maximize flow while minimizing environmental impact. Although screen 1323 defines a perforated metal plate, screens according to this disclosure may include other positive barriers, such as fish handling and return systems, cylindrical wedgewire screens, and fish net barriers. Screens according to this disclosure may include both positive, as described above, and behavioral barriers that encourage fish to swim away from the hydroelectric generator.

Avoiding the need to generate a constant displacement force within siphon pipe 1342 with external means provides additional efficiency gains. Indeed, additional liquid may be harnessed downstream of liquid source 1372. Additionally, siphon 1340 allows a designer to efficiently route liquid from liquid source 1372 to collection body 1360 where the most practical path to route the water requires routing the liquid upwards for a segment of the path.

Additionally, as liquid contained within discharge segment 1346 is drawn into collection body 1360, a partial vacuum is created within input segment 1345, allowing additional liquid to be drawn from liquid source 1372 into siphon pipe 1342. Once fluid communication is initiated between liquid source 1372 and collection body 1360, siphon pipe 1342 continues to draw liquid from liquid source 1372 to collection body 1360 without moving liquid through siphon pipe 1342 by external means. The ability to continuously draw liquid from liquid source 1372 by a self-sustaining suction force and to route the liquid upward for a portion of its length distinguishes siphon 1340 from a simple pipe feeding water to collection body 1360.

Primer pump 1344 is positioned along discharge segment 1346 proximate the second end of siphon pipe 1342. Siphon 1340 will not create the partial vacuum necessary to feed liquid into input segment 1345 unless liquid is discharged from discharge segment 1346. As a result, the unassisted communication of liquid from liquid source 1372 to collection body 1360 may not occur unless liquid is already contained within siphon 1340. Primer pump 1344 is configured to selectively apply a displacement force through siphon pipe 1342 to displace liquid contained in liquid source 1372 into discharge segment 1346. Primer pump 1344 is configured to selectively operate until a selected amount of liquid is contained within siphon pipe 1342, at which point siphon 1340 may commence communication of liquid from liquid source 1372 to collection body 1360 without any external force.

Siphon 1340 additionally includes siphon valve 1347 proximate the second end of siphon pipe 1342. Siphon valve 1347 is configured to selectively open to allow liquid flow through siphon pipe 1342. By selectively impeding liquid flow within siphon valve 1347, siphon valve 1347 allows a user to retain a volume of liquid within discharge segment 1346, potentially obviating the need to re-prime siphon 1340 for a subsequent use. Additionally, siphon valve 1347 allows a user to selectively cease siphoning operation.

Collection body 1360 is connected to and receives the output of siphon pipe 1342, internal generator output pipe 1377, and spillway pipe 1379. Collection body 1360 includes a head pipe 1361 and a pressure release pipe 1395. Collection body 1360 receives and collects liquid from internal generator output pipe 1377, siphon pipe 1342, and spillway pipe 1379. Collection body 1360 additionally routes contained liquid to head pipe 1361.

Head pipe 1361 defines a pipe connected on a first end to collection body 1360 and on a second end to generation unit 1310. Head pipe 1361 includes a head pipe valve 1397. Head pipe 1361 is configured to receive liquid from collection body 1360 to collect a selected quantity of the liquid to pressurize the liquid to a selected amount of head pressure prior to sending the liquid to generation unit 1310. Head pipe 1361 is sized to collect a head representing a sufficient amount of potential energy to drive generation unit 1310.

Head pipe 1361 includes head pipe valve 1397 attached proximate its connection with generation unit 1310. Head pipe valve 1397 is configured to selectively impede the flow of liquid from head pipe 1361 to generation unit 1310. Head pipe valve 1397 allows a user to impede the flow of liquid into generation unit 1310 until a sufficient head is generated within head pipe 1361.

Generation unit 1310 is connected to head pipe 1361. Generation unit 1310 includes a turbine and generator arrangement similar to generation unit 110. Generation unit 1310 is similarly configured to receive liquid from head pipe 1361 and use the liquid to drive the turbine and generator to produce electricity.

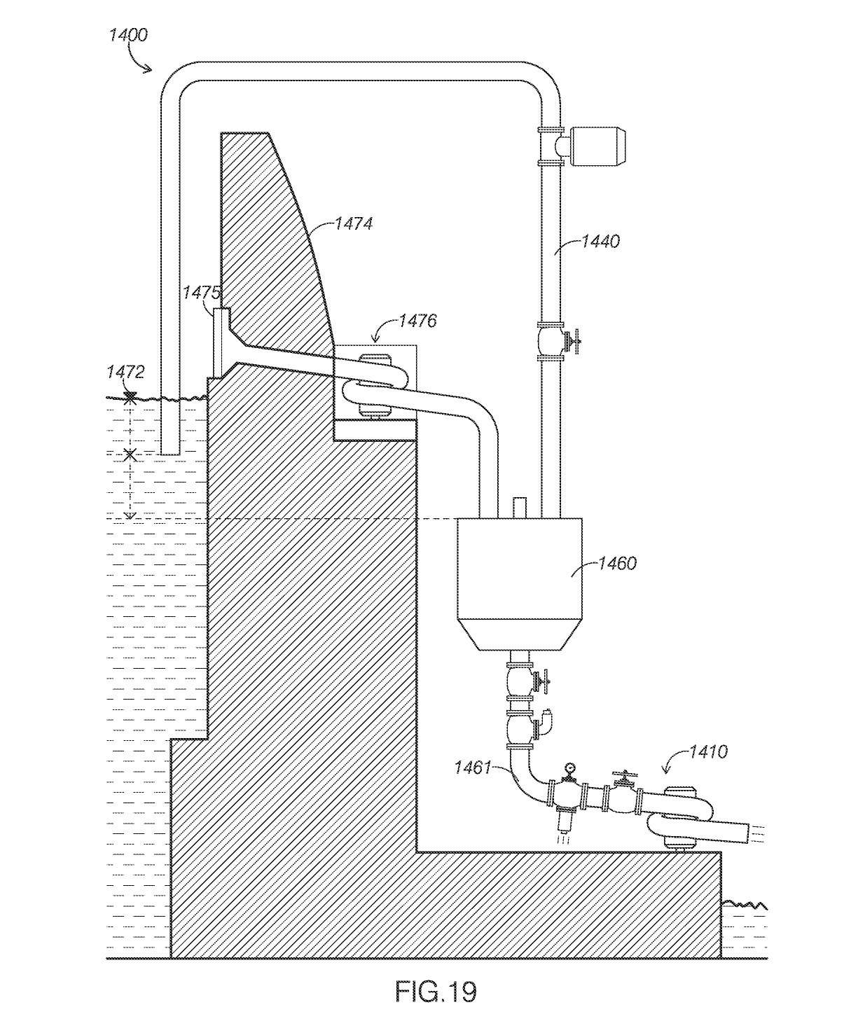

Turning attention to FIG. 19, a fifteenth example of a hydroelectric generator, hydroelectric generator 1400, will now be described. Hydroelectric generator 1400 shares many similar or identical features with previously disclosed examples of hydroelectric generators that are combined in unique and distinct ways. Thus, for the sake of brevity, each feature of hydroelectric generator 1400 will not be redundantly explained. Rather, key distinctions between hydroelectric generator 1400 and other previously disclosed examples of hydroelectric generators will be described in detail and the reader should reference the discussion above for features substantially similar between the hydroelectric generators.

As FIG. 19 shows, hydroelectric generator 1400 is similar to hydroelectric generator 1300. Specifically, it includes a siphon 1440 routed over a dam 1474 from a liquid source 1472 to a collection body 1460. Also similar to hydroelectric generator 1300, hydroelectric generator 1400 includes a dam generator 1476 configured to receive liquid from liquid source 1472 and to output to collection body 1460. Like hydroelectric generator 1300, hydroelectric generator 1400 routes liquid collected in collection body 1460 to a generation unit 1410 via a head pipe 1461.

A difference between hydroelectric generator 1400 and hydroelectric generator 1300 is the depth at which siphon 1440 extends within liquid source 1472. As FIG. 19 illustrates, dam 1474 includes a penstock 1475, by which liquid is routed from liquid source 1472 to dam generator 1476. Siphon 1440 extends below penstock 1475, whereas siphon 1340 does not.

Because siphon 1440 extends below penstock 1475, hydroelectric generator 1400 is able to siphon liquid from liquid source 1472 to collection body 1460 in conditions where the volume of liquid contained within liquid source 1472 is insufficient to drive dam generator 1476. This allows hydroelectric generator 1400 to produce efficiency gains by generating electricity at times in which a similar hydroelectric generator lacking a siphoning element would be at rest.

Although siphon 1440 extends below penstock 1475, certain hydroelectric generators may be unable to operate due to an insufficient volume of liquid within the liquid source even when the surface level of the liquid is above the dam's penstock. As a result, hydroelectric generators may include siphons that extend to any depth within a liquid source, whether the minimum amount is sufficient to power the dam interior generator or not. By extension, this disclosure specifically contemplates hydroelectric generators that are configured to operate in concert with a internal generator within a dam, separate from the internal generator, and/or both.

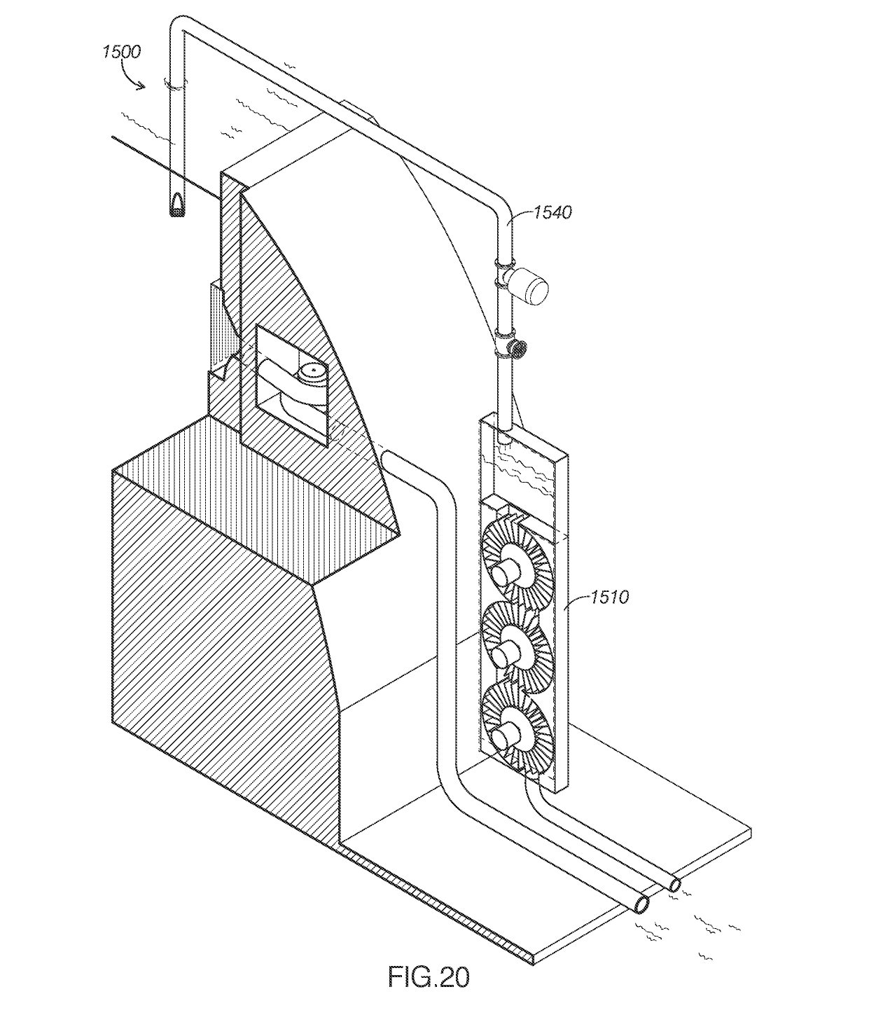

Turning attention to FIG. 20, a sixteenth example of a hydroelectric generator, hydroelectric generator 1500, will now be described. Hydroelectric generator 1500 shares many similar or identical features with previously disclosed examples of hydroelectric generators that are combined in unique and distinct ways. Thus, for the sake of brevity, each feature of hydroelectric generator 1500 will not be redundantly explained. Rather, key distinctions between hydroelectric generator 1500 and other previously disclosed examples of hydroelectric generators will be described in detail and the reader should reference the discussion above for features substantially similar between the hydroelectric generators.

Hydroelectric generator 1500 includes a siphon 1540 and a generation unit 1510. Hydroelectric generator 1500 is configured to siphon liquid and drive generation unit 1510, similar to hydroelectric generator 1300 and hydroelectric generator 1400. Hydroelectric generator 1500, however, is configured to operate independent of any other hydroelectric generation already occurring within or around the dam. Additionally, hydroelectric generator 1500 includes generation unit 1510 similar to hydroelectric generator 400, which obviates the need for the collection of siphoned liquid to a head prior to feeding the liquid through generation unit 1510.

Siphon 1540 is substantially similar to siphon 1440 and siphon 1340. A difference between siphon 1540 and previous siphons lies in its direct connection to generation unit 1510 without requiring the liquid to first be collected into a collection body and built to a head within a head pipe.

Generation unit 1510 is substantially similar to hydroelectric generator 400, which is a storage turbine hydroelectric generator. A storage turbine hydroelectric generator allows siphon 1540 to discharge directly into generation unit 1510. This allows hydroelectric generator 1500 to operate in low-flow contexts and eliminates the need for collection bodies and head pipes, which may be impractical and/or unsightly in some applications.

FIG. 20 illustrates hydroelectric generator 1500 including a storage turbine hydroelectric generator, but hydroelectric generators including siphons in a similar manner to hydroelectric generator 1500 that include any of the disclosed storage turbine hydroelectric generators are equally within this disclosure.

FIGS. 18-20 specifically illustrate hydroelectric generators using siphoning means in dam contexts. However, the disclosed siphon and generator designs are not specifically limited to use in dam contexts.

Specifically, the disclosed siphon and generator designs may be used in any context where a generator is placed at a lower elevation than a liquid source and there is some benefit to elevating a segment of the siphon pipe. This specifically includes features such as elevated lakes and cascading segments of liquid channels. Often, the aesthetic beauty and the reliance of the surrounding ecosystem on the liquid source precludes harnessing the potential energy in the liquid source with current technologies. However, the siphon-fed generator systems disclosed may provide a less intrusive and/or harmful means of accomplishing this goal.

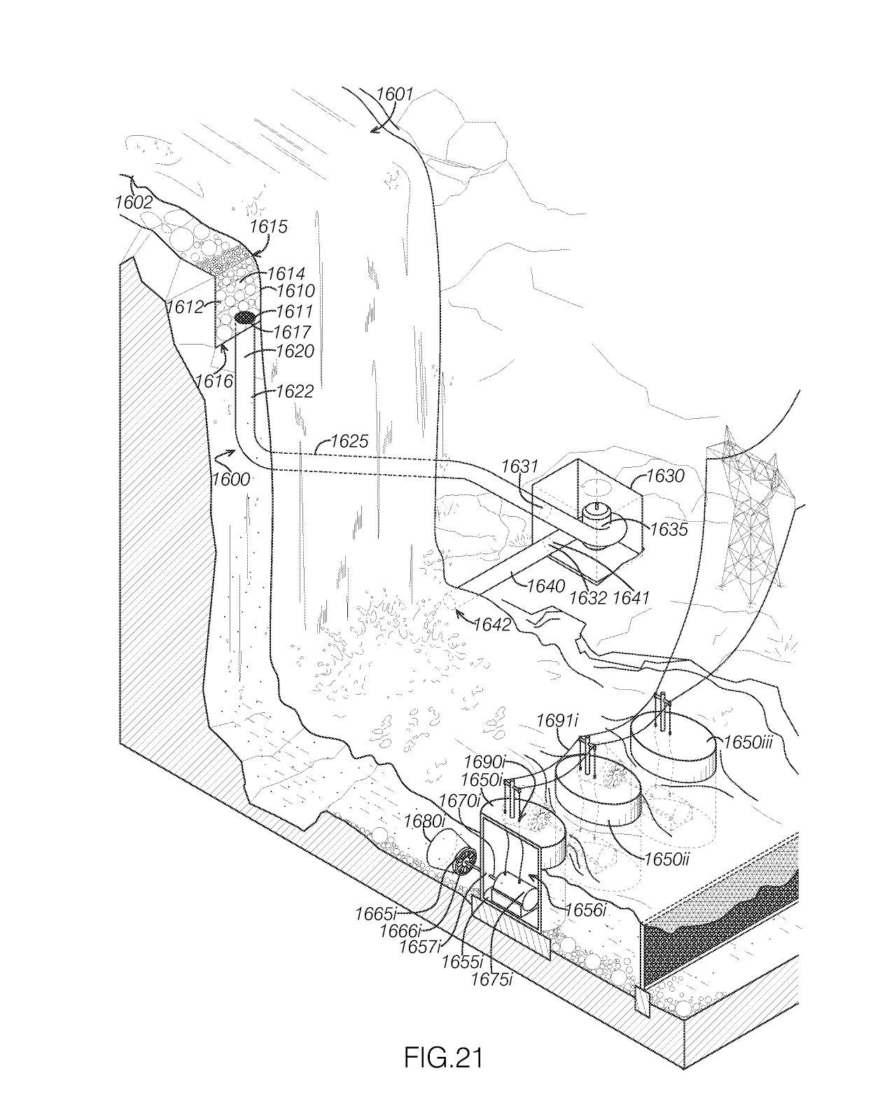

Turning attention to FIG. 21, a seventeenth example of a hydroelectric generator, hydroelectric generator 1600 will now be described. Hydroelectric generator 1600 generates hydroelectric energy from a liquid drawn upstream of a cascading water feature 1601, including a waterfall or any other liquid feature defining a drop in elevation, in two stages. Cascading water feature 1601 defines a subterranean section that includes the area below the more elevated portion of liquid source 1602. As FIG. 20 shows, hydroelectric generator 1600 includes a liquid source 1602, an intake 1610, a columnar conduit 1620, a generation unit housing 1630, a generation unit 1635, and a generation unit output 1640 in its first stage, and a first downstream generation unit 1650i, a second downstream generation unit 1650ii, and a third downstream generation unit 1650iii in its second stage.

In the first stage, hydroelectric generator 1600 intakes a selected amount of liquid from liquid source 1602 upstream of cascading water feature 1601 through intake 1610 and collects and pressurizes the liquid to a selected amount of head pressure in columnar conduit 1620. Upon pressurizing the liquid to the selected pressure, columnar conduit 1620 sends the liquid to generation unit 1635, which is within a generation unit housing 1630, where the liquid drives generation unit 1635 and produces electricity. After generating electricity, generation unit output 1640 routes generation unit 1635's output to liquid source 1602 downstream of cascading water feature 1601.

In the second stage, hydroelectric generator 1600 generates electricity through three downstream generators submerged within a liquid source possessing a current downstream of the cascading water feature. Each downstream generator is designed to harness the liquid source's current to generate electricity within a substantially water-tight generator housing.

As FIG. 21 illustrates, hydroelectric generator 1600 includes intake 1610 positioned within a liquid source 1602. Intake 1610 includes an opening 1611 and a filter 1612. Intake 1610 collects the liquid used by hydroelectric generator 1600 to generate electricity through opening 1611 while implementing filter 1612 to prevent wildlife and other unwanted materials from entering into hydroelectric generator 1600. More precisely, intake 1610 collects liquid from liquid source 1602, passes the liquid through filter 1612, and routes the liquid through opening 1611 to columnar conduit 1620 after passing through filter 1612.

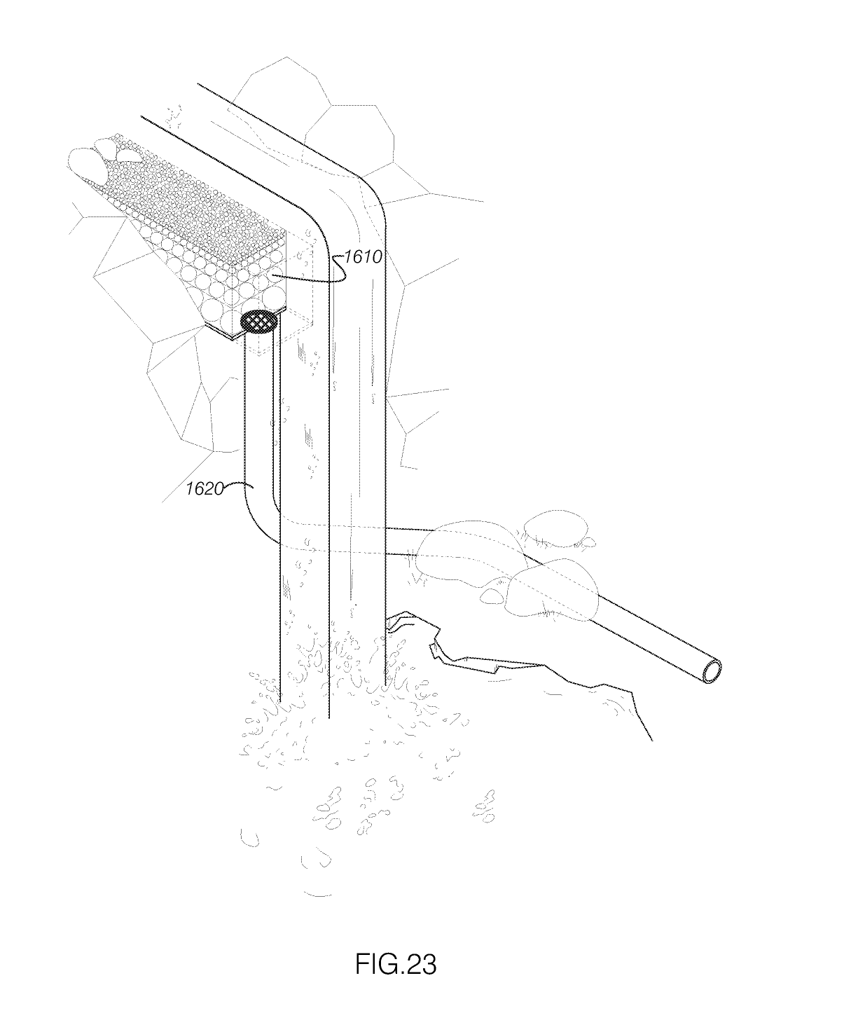

Turning to FIG. 23, intake 1610 includes filter 1612 positioned above opening 1611, designed to prevent wildlife and other unwanted matter from entering hydroelectric generator 1600's fluid system. Filter 1612 includes a French drain 1614 and an intake screen 1617. French drain 1614 and intake screen 1617 provide a two stage filtration process, which may be employed alone, in concert, or excluded entirely. First, French drain 1614 provides a natural looking drain on the base of a river bed that substantially prevents wildlife and other unwanted bodies from passing through opening 1611. Second, intake screen 1617 prevents sediment from French drain 1614 from passing through opening 1611 and prevents, along with French drain 1614, wildlife and other unwanted bodies from passing through opening 1611.

As FIG. 23 illustrates, French drain 1614 extends from a top 1615 to a bottom 1616. French drain 1614 defines a natural appearing filter that includes several vertical layers of rocks, with each layer getting progressively finer from top 1615 to bottom 1616. French drain 1614 is configured to naturally blend intake 1610 with hydroelectric generator 1600's environs, while applying a first level of filtration to water collected by intake 1610.

As FIG. 23 illustrates, intake screen 1617 defines a mesh that extends over opening 1611. Intake screen 1617's mesh includes openings that are liquid permeable, but are small enough to substantially prevent wildlife and other unwanted bodies from passing through opening 1611. Intake screen 1617's mesh openings are specifically sized to prevent sediment from the finest layer of French drain 1614 from passing through opening 1611. However, this disclosure specifically considers the use of screens similar to all of those previously described in this disclosure in hydroelectric generators similar to hydroelectric generator 1600.

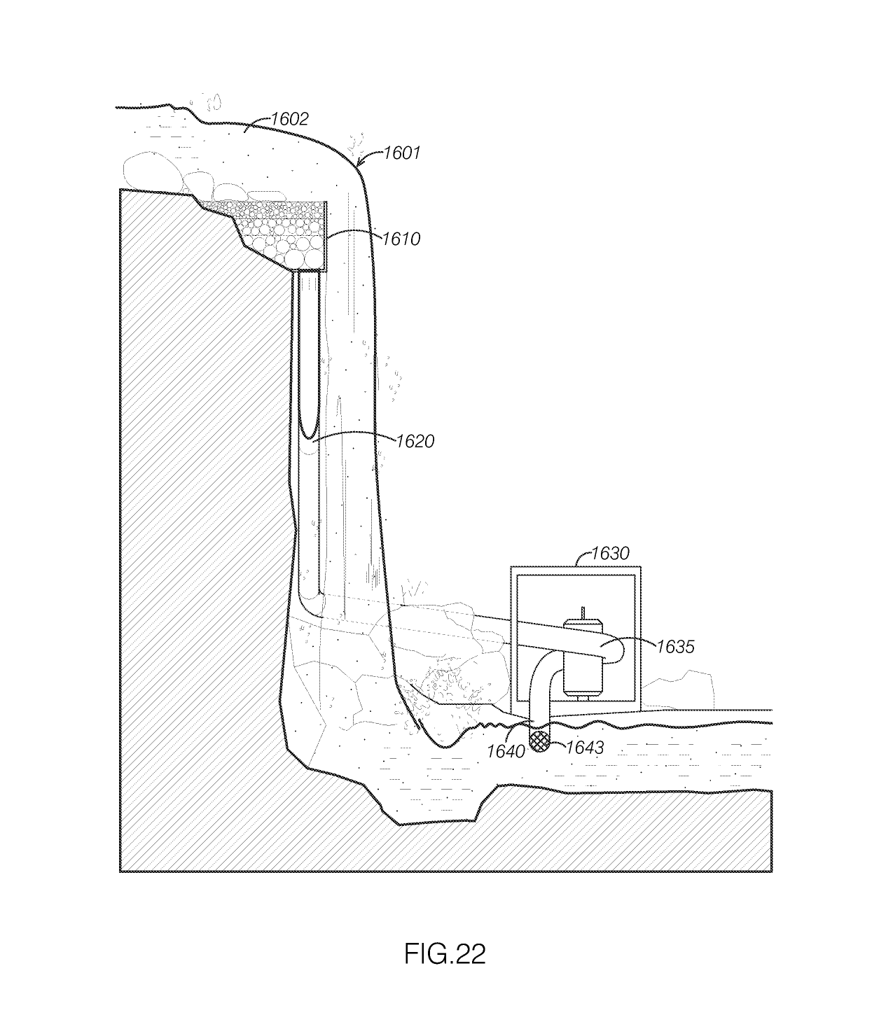

Turning to FIGS. 21 and 22, hydroelectric generator 1600 includes columnar conduit 1620 in fluid communication with intake 1610. Columnar conduit 1620 includes a vertical segment 1622 and a horizontal segment 1625. Columnar conduit 1620 is configured to collect a selected quantity of liquid from intake 1610 and pressurize the liquid to a selected amount of head pressure prior to communicating the liquid to generation unit 1635. Additionally, columnar conduit 1620 is configured to route the liquid from a first horizontal position proximate to cascading water feature 1601 to a second horizontal position distal to cascading water feature 1601, where generation unit housing 1630 and generation unit 1635 impart a lesser impact on cascading water feature 1601's visual splendor.

As FIG. 22 illustrates, vertical segment 1622 is substantially vertically oriented and is configured to pressurize the collected liquid to a head. As FIG. 22 also illustrates, horizontal segment 1625 is oriented substantially horizontally and is configured to route the collected liquid away from cascading water feature 1601 to minimize the aestethic impact around the cascading water feature.

Turning back to FIG. 21, hydroelectric generator 1600 includes generation unit housing 1630 that defines an interior containing generation unit 1635. Generation unit housing 1630 provides shelter for generation unit 1635, substantially preventing damage to generation unit 1635 from the elements or from wildlife, plantlife, and other potentially harmful elements within its environments. Generation unit housing 1630 includes an input interface 1631 configured to receive columnar conduit 1620 into its interior and an output interface 1632 configured to receive generation unit output 1640 into its interior, allowing generation unit 1635 to operate under shelter.

Generation unit 1635 is substantially similar to generation unit 110 and is similarly configured to generate electricity using pressurized liquid collected from liquid source 1602. More precisely, generation unit 1635 is configured to receive the pressurized liquid from columnar conduit 1620 to drive a generator producing hydroelectric power.

As FIG. 21 illustrates, generation unit output 1640 defines an output conduit connected to generation unit 1635 on a first end 1641 and extends to an output end 1642 proximate liquid source 1602 downstream of cascading water feature 1601 and upstream of hydroelectric generator 1600's downstream generators. By outputting the liquid back to liquid source 1602, generation unit output 1640 completes a system where substantially all of the liquid collected from liquid source 1602 is returned to its source downstream of the cascading water feature. As a result, hydroelectric generator 1600 allows a user to selectively re-route a portion of liquid source 1602's liquid, providing some control over the amount of liquid flowing over cascading water feature 1601. Additionally, by outputting the liquid to liquid source 1602 upstream of hydroelectric generator 1600's downstream generators, generation unit output 1640 allows hydroelectric generator 1600 to harness the liquid's potential energy at a second point. Generation unit output 1640 additionally includes a screen 1643 configured to prevent fish, wildlife, and/or other materials from approaching generation unit 1635.

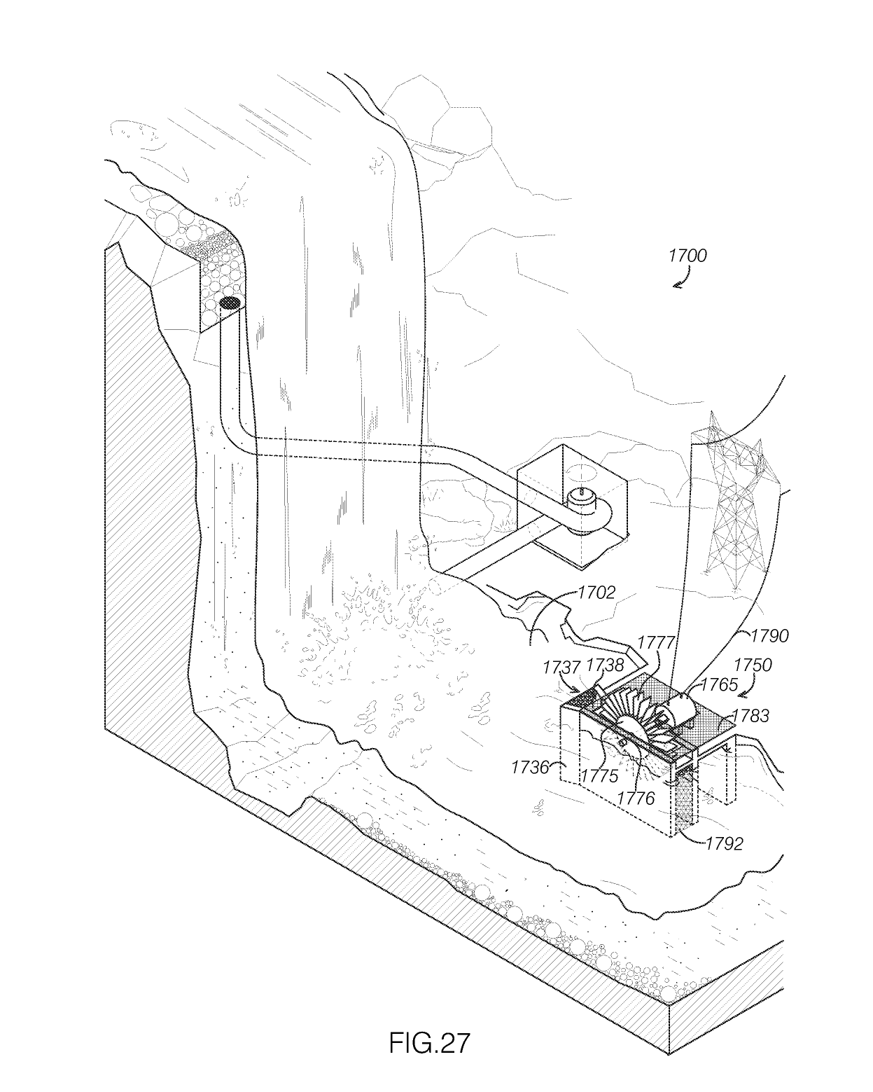

As FIGS. 21 and 23-26 illustrate, hydroelectric generator 1600 includes first downstream generation unit 1650i, second downstream generation unit 1650ii, and third downstream generation unit 1650iii positioned in parallel across liquid source 1602 downstream of cascading water feature 1601. This disclosure only discusses first downstream generation unit 1650i in detail, as second downstream generation unit 1650ii and third downstream generation unit 1650iii are substantially similar to first downstream generation unit 1650i and illustrated only to show a possible configuration of multiple downstream generators operating in concert. FIG. 21 shows this arrangement in a perspective view, whereas FIG. 26 illustrates a top view of this arrangement.

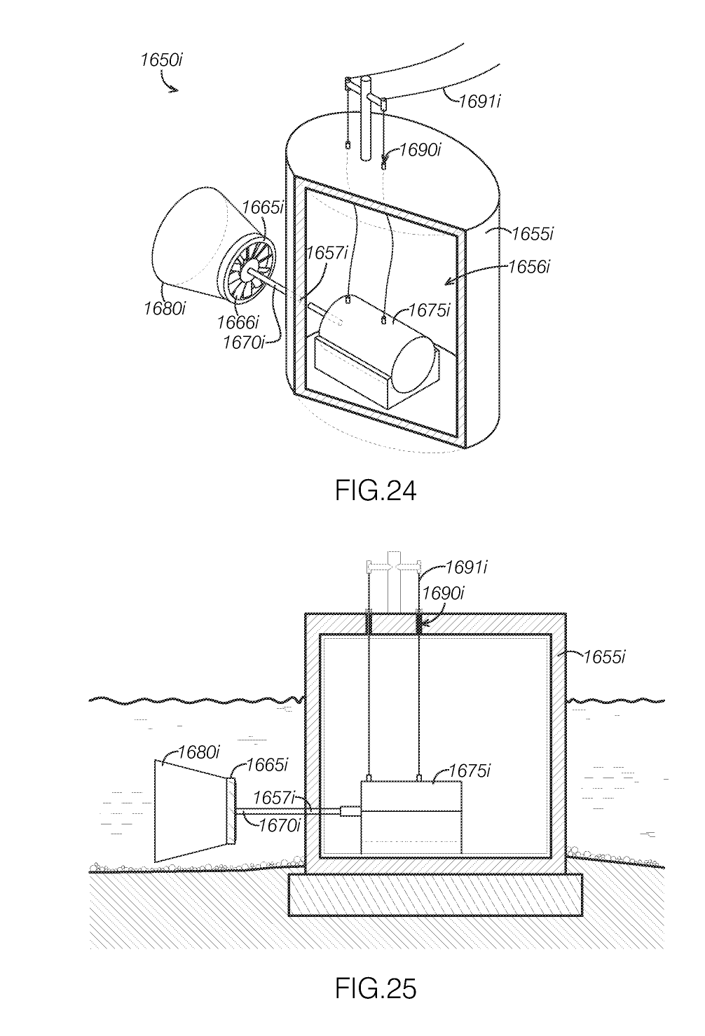

As FIG. 24 illustrates, first downstream generation unit 1650i includes a generator housing 1655i, a turbine 1665i, a generator interface 1670i, a generator 1675i, and a nozzle 1680i. First downstream generation unit 1650i is configured to use liquid source 1602's current to drive a generator and produce hydroelectric energy. Additionally, first downstream generation unit 1650i generates this energy within a substantially water-tight generator housing connected by a wire to an external power system without exposing metal contained within the wire or the connection between the wire and generator housing 1655i to the liquid within liquid source 1602.

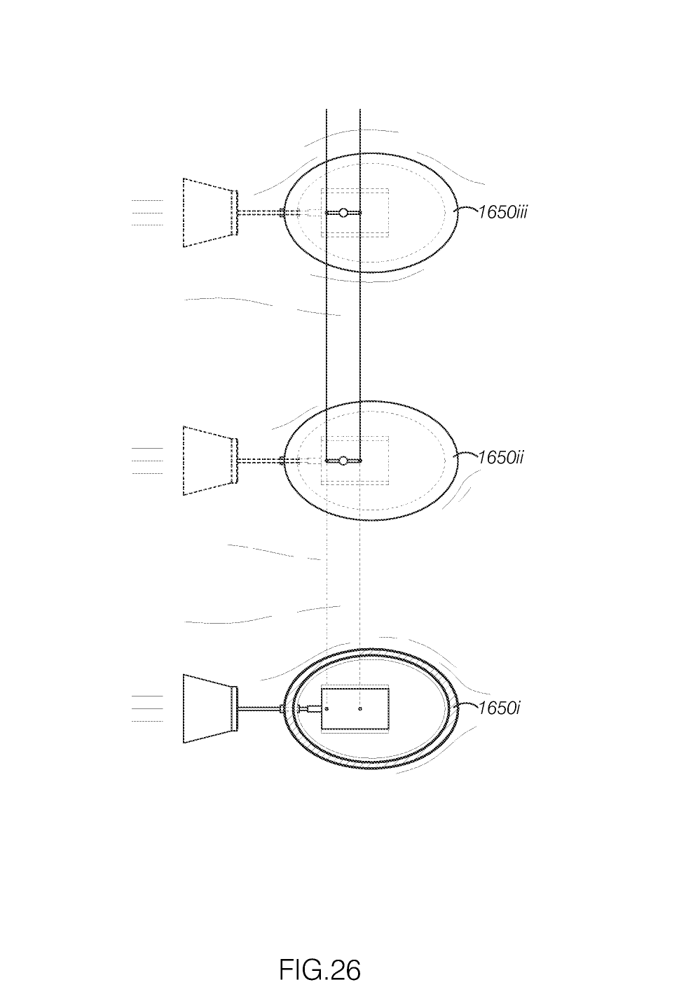

Looking to FIGS. 24 and 25, generator housing 1655i is a rigid structure affixed to the base of liquid source 1602 made of a liquid impermeable material. As FIG. 24 illustrates, generator housing 1655i defines an interior 1656i that contains generator 1675i. Generator housing 1655i additionally defines a generator interface opening 1657i and a power system interface 1690i. Generator housing 1655i is configured to provide a substantially dry space within liquid source 1602 wherein generator 1675i may operate and distribute electricity. As FIG. 24 illustrates, generator housing 1655i is substantially closed when in operation; specifically, the two functionally necessary accesses to interior 1656i, generator interface opening 1657i and power system interface 1690i, are closed during operation.

As FIG. 24 illustrates, generator interface opening 1657i is configured to flushly receive generator interface 1670i such that liquid from liquid source 1602 is not permitted to pass into interior 1656i when hydroelectric generator 1600 is in operation.

Additionally, power system interface 1690i includes an opening configured to flushly receive a wire 1691i connected to an external power system and a sheath of substantially liquid-impermeable material through which the wire is routed. The sheath ensures that the metal contained within the wire is not exposed to the liquid within liquid source 1602. When wire 1691i is routed through power system interface 1690i, power system interface 1690i is configured to substantially prevent liquid from liquid source 1602 from passing into interior 1656i. When so routed, wire 1691i allows generator 1675i to be connected to an external power system without exposing wire 1691i's internal metal to liquid source 1602 when transmitting electricity to the power system.

As FIG. 24 shows, generator 1675i is contained within interior 1656i. Generator 1675i is substantially similar to generator 134, albeit driven by turbine 1665i via generator interface 1670i.

Turning to FIG. 23, first downstream generation unit 1650i includes turbine 1665i positioned within liquid source 1602 exterior to generator housing 1655i's interior 1656i. Turbine 1665i includes a plurality of blades 1666i, which are pushed by liquid source 1602's current to drive turbine 1665i.

Turbine 1665i is connected to generator 1675i by generator interface 1670i, substantially defining a cam. As previously mentioned, generator interface 1670i is routed through generator interface opening 1657i such that liquid is substantially prevented from entering interior 1656i during operation. As turbine 1665i is driven by liquid source 1602, generator interface 1670i applies this power to generator 1675i. This design, with generator interface 1670i serving to translate turbine 1665i's rotational motion to generator 1675i, allows the exterior turbine 1665i to drive the interior generator 1675i while generator housing 1655i prevents generator 1675i and attached electrical equipment from being exposed to turbine 1665i's wet environment.

As FIG. 23 illustrates, first downstream generation unit 1650i additionally includes nozzle 1680i extending from generator housing 1655i near turbine 1665i. Nozzle 1680i defines a hollow truncated cone made of a substantially liquid-impermeable material. Nozzle 1680i substantially directs a selection of liquid source 1602's current more directly towards turbine 1665i. More precisely, the pressure imparted on turbine 1665i's blades 1666i is increased as the current approaches the nozzle 1680i's tapering end.

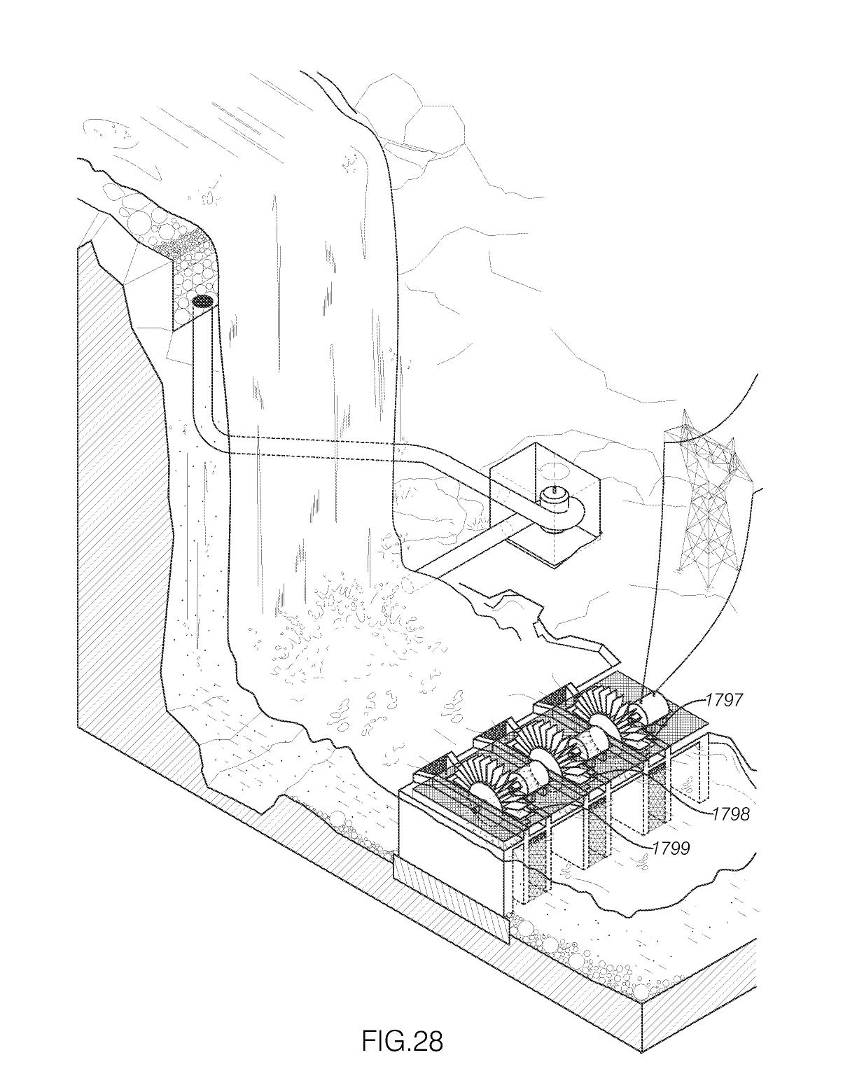

Turning to FIG. 27, an eighteenth example of a hydroelectric generator, hydroelectric generator 1700, will now be described. Hydroelectric generator 1700 includes is substantially similar to hydroelectric generator 1600, albeit with a significantly different downstream generator design. Thus, for the sake of brevity, each feature of hydroelectric generator 1700 will not be redundantly explained. Rather, the description of hydroelectric generator 1700 will be limited to the description of the alternative downstream generator.

As FIG. 27 illustrates, hydroelectric generator 1700 includes a downstream generator 1750 including a turbine 1775 positioned in a liquid source 1702 possessing a current. Downstream generator 1750 is configured to generate electricity via a generator proximate to turbine 1775's center, which is spaced from liquid source 1702 because of turbine 1775's diameter.

As FIG. 27 shows, hydroelectric generator 1700 includes turbine 1775 positioned within liquid source 1702. Turbine 1775 defines a center 1776 and a plurality of paddles 1777 extending radially around its center. Looking at FIG. 27, paddles 1777 are configured to have a length greater than liquid source 1702's depth. In operation, the paddles 1777 are submerged within liquid source 1702 to the greatest extent possible, thereby leaving center 1776 positioned above liquid source 1702's surface. When submerged, the paddles 1777 are driven by liquid source 1702's current, thereby driving turbine 1775. When operating in this manner, turbine 1775 is able to efficiently harness liquid source 1702's current while retaining center 1776 above liquid source 1702.

As FIG. 27 illustrates, hydroelectric generator 1700 additionally includes a generator 1765 connected to turbine 1775 proximate center 1776. Turbine 1775 is configured to drive generator 1765 when driven by paddles 1777. When so driven, generator 1765 produces hydroelectric energy that may be distributed to an external power system by wire 1790.

As FIG. 27 shows, turbine 1775 is partially enclosed within an abutment 1736. Abutment 1736 defines a reinforced concrete structure defining a channel 1737 through which liquid is routed to drive turbine 1775. Similar to nozzle 1680i, channel 1737 increases the pressure of a flowing liquid within the channel as the liquid approaches a tapered segment 1738 of channel 1737, allowing the liquid flowing through channel 1737 to have a greater force per unit area than the unpressurized liquid in liquid source 1702 around abutment 1736. As a result, turbine 1775 is positioned in channel 1737, either within tapered segment 1738 or downstream of tapered segment 1738, to harness the increased pressure. Abutment 1736 additionally includes a catwalk 1783 attached across its top with an open portion through which a portion of turbine 1775 is routed. Catwalk 1783 is made of steel, and provides an operator a means of approaching downstream generator 1750 for maintenance or other manual manipulation of downstream generator 1750.

As FIG. 27 shows, downstream generator 1750 additionally includes a screen 1792 extending across abutment 1736 downstream of turbine 1775 and a screen 1792 extending across abutment 1736 upstream of turbine 1775, each screen 1792 is configured to substantially restrict fish and other wildlife from approaching the turbine. Additional or alternative screens may also be used to prevent other unwanted materials from approaching the turbine. Downstream generators similar to downstream generator 1750 may include screens that include, but are not limited to, any other screens included in this disclosure.

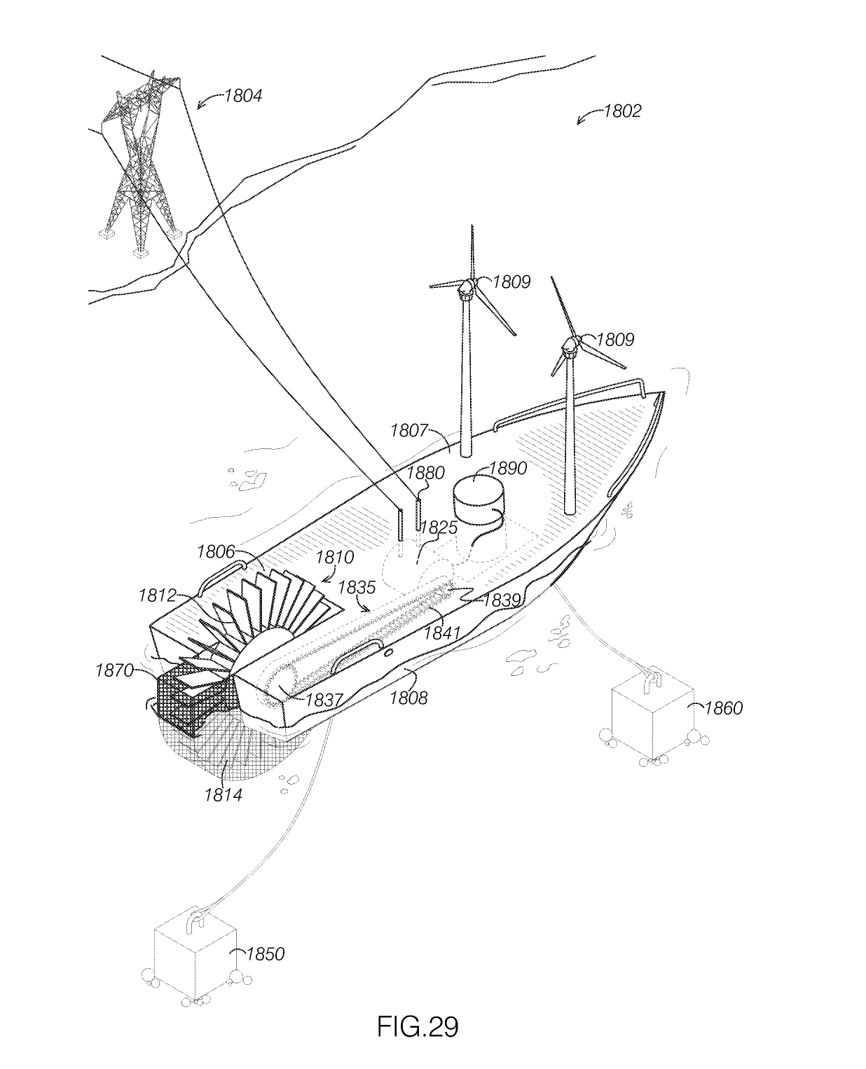

Turning to FIG. 28, one can see that multiple downstream generators similar to downstream generator 1750, specifically including a downstream generator 1797, a downstream generator 1798, and a downstream generator 1799, may be used in parallel across a river, similar to first downstream generation unit 1650i, second downstream generation unit 1650ii, and third downstream generation unit 1650iii.

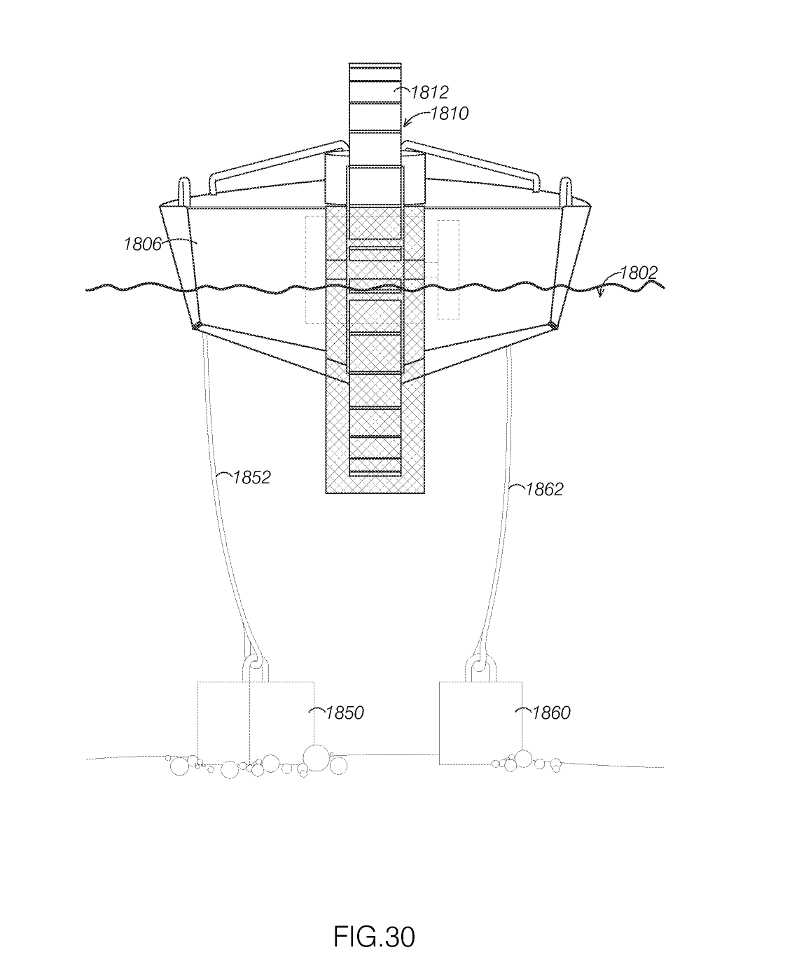

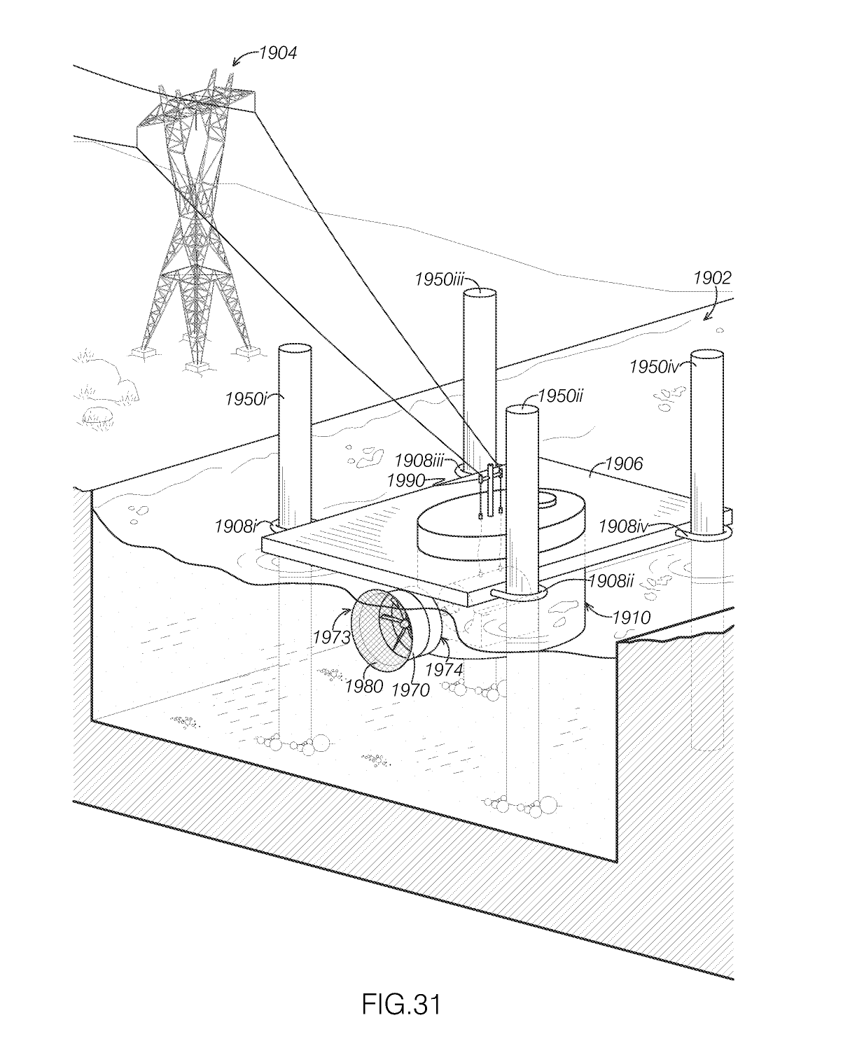

With reference to FIGS. 29 and 30, hydroelectric generator 1800 is configured for harnessing potential energy from a liquid source 1802 by driving a turbine with liquid source 1802's current while being buoyantly supported within liquid source 1802. Hydroelectric generator 1800 is also configured to distribute generated electricity to an external power system 1804. As FIG. 29 illustrates, hydroelectric generator 1800 includes a platform 1806, a generation unit 1810, a first anchor 1850, a second anchor 1860, a screen 1870, an electrical interface 1880, and electrical storage 1890. Because hydroelectric generator 1800 is buoyantly supported, hydroelectric generator 1800 is able to maintain a turbine in liquid source 1802 at a selected depth as liquid source 1802's surface level varies.

As FIG. 29 illustrates, platform 1806 provides a surface to support generation unit 1810. Platform 1806 produces a selected buoyancy in liquid source 1802 to maintain hydroelectric generator 1800 suspended in liquid source 1802 at a selected depth. By adjusting platform 1806's depth, generation unit 1810 is similarly placed at a selected depth to efficiently harness liquid source 1802's potential energy.

Platform 1806's buoyancy may be adjusted in at least two ways. First, platform 1806 may be constructed from materials of a selected density. Second, weighted materials may be added to or removed from the top of platform 1806, allowing a user to adjust generation unit 1810's position without modifying platform 1806.

As FIG. 29 illustrates, platform 1806 defines a boat 1807 including a hull 1808. Both free-floating and anchored boats are considered for use in supporting generation units. Boats used in this context may include, for example, reserve or “mothballed” military vessels.

As FIG. 29 shows, platform 1806 includes a plurality of wind generators 1809 extending from its surface, each connected to electrical interface 1880. This collection of wind generators could define a “wind farm” in some contexts. Wind generators 1809 allow hydroelectric generator 1800 to harness potential energy from wind as it harnesses a liquid source's potential energy via generation unit 1810. As a result, hydroelectric generator 1800 produces a greater amount of renewable energy than it would by harnessing liquid source 1802's potential energy alone.

As FIG. 30 illustrates, generation unit 1810 is attached to platform 1806 and partially submerged within liquid source 1802. As FIG. 29 shows, generation unit 1810 includes a waterwheel 1812, a generator 1825, and a drivetrain 1835. Generation unit 1810 is configured to harness potential energy in liquid source 1802 by driving waterwheel 1812 with liquid source 1802's current and communicating waterwheel 1812's work to drive generator 1825.

As FIG. 29 illustrates, waterwheel 1812 is partially submerged in liquid source 1802 with a blade 1814 extending into liquid source 1802. Blade 1814 opposes liquid source 1802's current and uses the resultant force to drive waterwheel 1812. Waterwheel 1812 is an undershot water wheel; wheels used in similar designs may, however, include overshot, backshot, breastshot, or horizontal configurations. Other known water wheel configurations may also be used.

As FIG. 29 illustrates, generator 1825 is spaced from waterwheel 1812 on platform 1806. Generator 1825 is configured to generate electricity when driven by waterwheel 1812 via drivetrain 1835.

As FIG. 29 shows, drivetrain 1835 drivingly connects waterwheel 1812 to generator 1825. Drivetrain 1835 includes a first wheel 1837, a second wheel 1839, and a linkage 1841. As FIG. 29 illustrates, first wheel 1837 defines a sprocket drivingly attached to waterwheel 1812 and second wheel 1839 defines a sprocket drivingly attached to generator 1825. Linkage 1841 defines a chain connecting second wheel 1839 to first wheel 1837 to communicate waterwheel 1812's rotation to generator 1825 spaced from waterwheel 1812.

Although FIG. 29 illustrates drivetrain 1835 implementing a two-sprocket system with a chain linked between, this particular drivetrain arrangement is not required. Specifically, this disclosure specifically contemplates using implementing toothless with a belt extending between them. Additionally or alternatively, pulley systems may additionally or alternatively be used, implementing chains, belts, or other suitable elements as linkages.

Although this disclosure illustrates a simple gear ratio including two wheels and a single linkage between them, such a design is not specifically required. For example, this disclosure specifically contemplates gear systems with more than two wheels, including arrangements that include multiple wheels rotating about the same axis and those that do not. Additionally or alternatively, multiple linkages may be implemented. Some examples may include a transmission including a clutch or clutches which allow shifting between multiple gear ratios. For example, a drivetrain may include a transmission with a clutch that engages and disengages chains from sprockets to adjust a selected gear's relative rotational velocity.

As FIG. 29 shows, first wheel 1837 and second wheel 1839 have different radii, defining a gear ratio. This allows waterwheel 1812 to drive generator 1825 at a different rotational velocity than waterwheel 1812's own rotational velocity. FIG. 29 illustrates drivetrain 1835 with a front sprocket smaller than the rear sprocket, but this is not specifically required. Additionally, drivetrains are not required to have a dual-sprocket and chain configuration as illustrated in FIG. 29.

As FIG. 30 illustrates, first anchor 1850 is connected to platform 1806 near a rear end of platform 1806 and extends near liquid source 1802's bottom. First anchor 1850 includes an anchor connector 1852. First anchor 1850 maintains platform 1806 in a substantially static position during operation by resisting platform 1806's movement within liquid source 1802. By resisting platform 1806's movement, waterwheel 1812 is able to more efficiently harness liquid source 1802's potential energy.

FIG. 30 illustrates anchor connector 1852 as a flexible line using tension to maintain platform 1806 in position. This disclosure, however, equally contemplates rigid lines which, and these rigid lines may implement forces other than tension to maintain platforms in substantially fixed positions. For example, certain embodiments may implement metal bars or posts extending from the anchor.

As FIG. 30 illustrates, anchor connector 1852 extends between first anchor 1850 and platform 1806 to retain platform 1806 proximate first anchor 1850. Anchor connector 1852 is flexible, allowing platform 1806 some freedom to move within liquid source 1802. A user may adjust anchor connector 1852's length to adjust platform 1806's ability to move relative first anchor 1850.

As FIG. 30 shows, second anchor 1860 is spaced from first anchor 1850 and is similarly attached to platform 1806. Second anchor 1860 restricts platform 1806's movement at a second point, thereby restricting platform 1806's rotation around first anchor 1850. By restricting platform 1806's rotation, second anchor 1860 allows waterwheel 1812 to more efficiently harness liquid source 1802's potential energy. Second anchor 1860 is connected by an anchor connector 1862 substantially similar to anchor connector 1852. In some contexts, one or more anchors, such as first anchor 1850, may be used to moor platform 1806 in a tension-leg platform configuration.

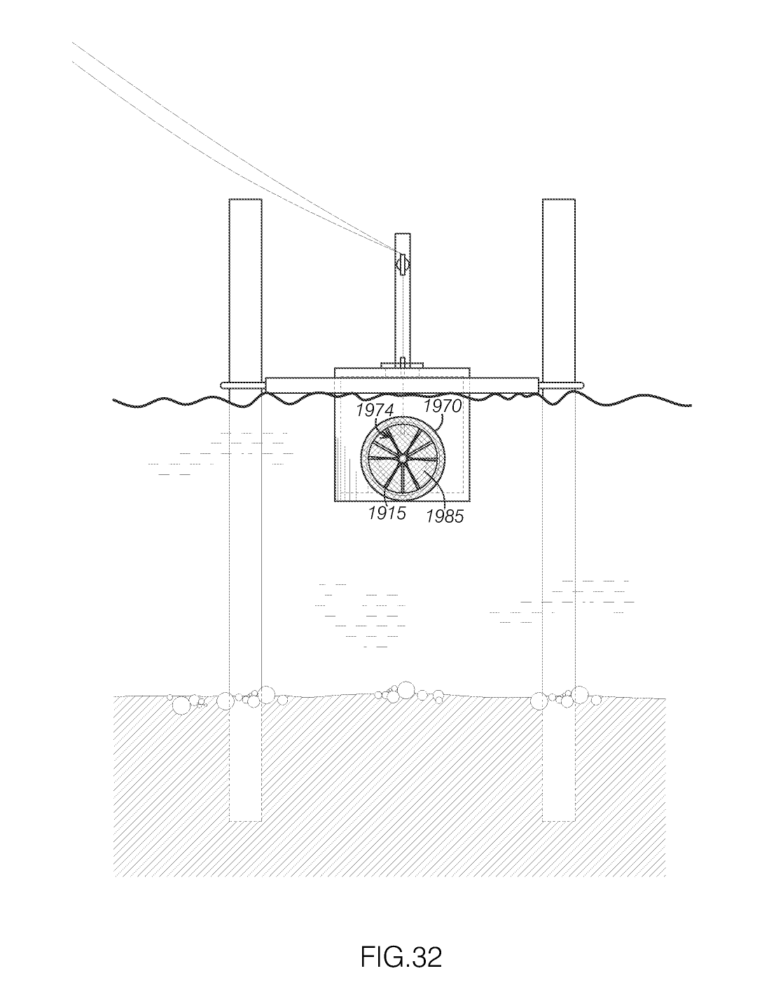

Hydroelectric generator 1800 implements two anchors, as second anchor 1860 restricts movement of platform 1806 around first anchor 1850. This disclosure, however, specifically contemplates implementing additional anchors to further stabilize platforms, including, but not limited to, examples that include four or more anchors. For example, FIG. 31 illustrates a four-support design wherein a four-anchor system could be used.

As FIG. 29 illustrates, screen 1870 encloses the submerged portion of waterwheel 1812 to prevent inadvertent contact with wildlife. Screens implemented in this manner may be similar to any screen disclosed herein.

As FIG. 29 shows, electrical interface 1880 is positioned on top of platform 1806 to allow hydroelectric generator 1800 to connect to external power systems via a wire 1884.

FIG. 29 illustrates electrical storage 1890 defining a battery positioned on platform 1806 and connected to electrical interface 1880. Electrical storage 1890 may store generated electrical power. Storing generated power may be useful when it is impractical or impossible to connect to an external power system.

With reference to FIGS. 31-33, hydroelectric generator 1900 is configured for harnessing potential energy from a liquid source 1902 by driving a turbine with liquid source 1902's current while being buoyantly supported within liquid source 1902. Hydroelectric generator 1900 is configured to distribute generated energy to an external power system 1904. As FIG. 31 illustrates, hydroelectric generator 1900 includes a platform 1906, a generation unit 1910, a first post 1950i, a second post 1950ii, a third post 1950iii, a fourth post 1950iv, a nozzle 1970, a first screen 1980, a second screen 1985, and an electrical interface 1990.

As FIG. 31 illustrates, platform 1906 is buoyant and remains suspended in liquid source 1902, similar to platform 1806. Platform 1906 includes a first post receiver 1908i, a second post receiver 1908ii, a third post receiver 1908iii, and a fourth post receiver 1908iv. Each post receiver includes an opening configured to slidingly receive a post, thereby collectively retaining platform 1906 is a substantially fixed horizontal position. Though not illustrated, platform 1906 is configured to support one or more wind generators, similar to platform 1806.

As FIG. 31 illustrates, generation unit 1910 is substantially similar to generation unit 1650i. Generation unit 1910, however, is supported at a selected height in liquid source 1902 by platform 1906 instead of being affixed to the liquid source's base. Generation unit 1910 includes a rotor 1915 configured to be driven by current in liquid source 1902. Rotor 1915 is configured to drive a connected generator 1925 contained within a substantially water-tight housing 1917 as it is driven by a current within liquid source 1902.

As FIG. 31 illustrates, first post 1950i, second post 1950ii, third post 1950iii, and fourth post 1950iv extend vertically liquid source 1902 from liquid source 1902's base to above liquid source 1902's surface level proximate the corners of platform 1906. First post 1950i, second post 1950ii, third post 1950iii, and fourth post 1950iv define piles driven into the floor of liquid source 1902, but other posts extending through liquid source 1902 are within this disclosure. These posts may additionally or alternatively define spars in certain contexts.

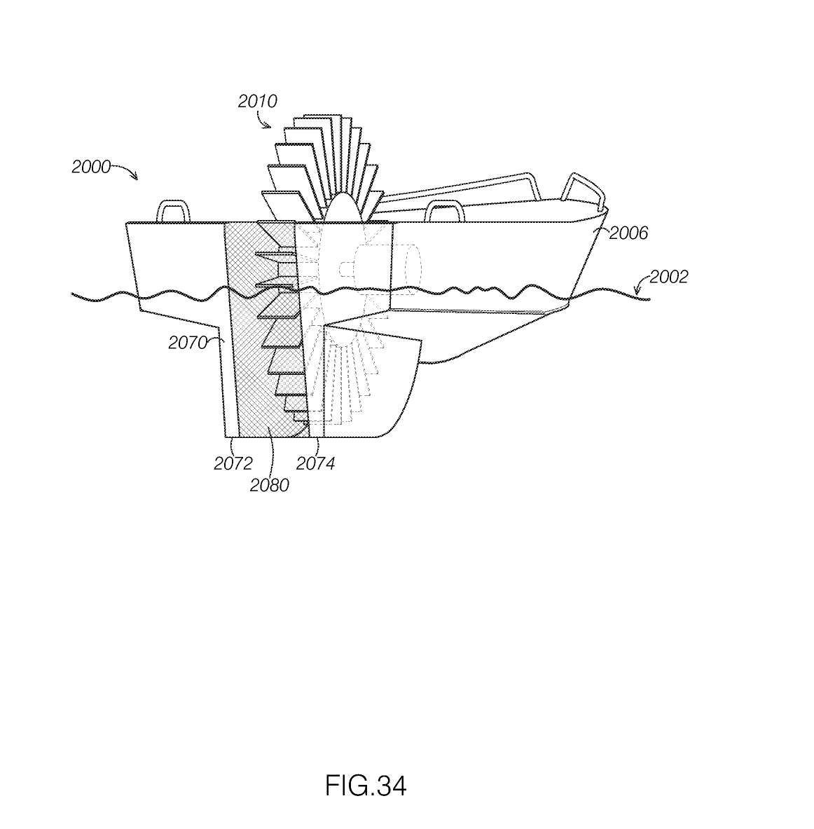

As FIG. 31 illustrates, first post 1950i, second post 1950ii, third post 1950iii, and fourth post 1950iv are slidingly inserted within a corresponding post receiver, thereby using the posts to retain platform 1906. By slidingly mounting platform 1906 on posts, hydroelectric generator 1900 adjusts to liquid source 1902's varying surface level by vertically adjusting rotor 1915's position to liquid source 1902's changing surface level. FIG. 33 illustrates in phantom lines hydroelectric generator 1900 adjusting to a lowered configuration when as liquid source 1902's surface level drops.

As FIG. 31 illustrates, nozzle 1970 defines a hollow truncated cone, similar to nozzle 1680i, that encloses rotor 1915 within an enclosed chamber 1972. Nozzle 1970 directs a selection of liquid source 1902's current more directly towards rotor 1915.

As FIG. 31 illustrates, first screen 1980 is located over an ingress opening proximate an ingress side 1973 of nozzle 1970. First screen 1980 restricts wildlife from inadvertently contacting rotor 1915. Screens implemented in this manner may be similar to any screen disclosed herein.

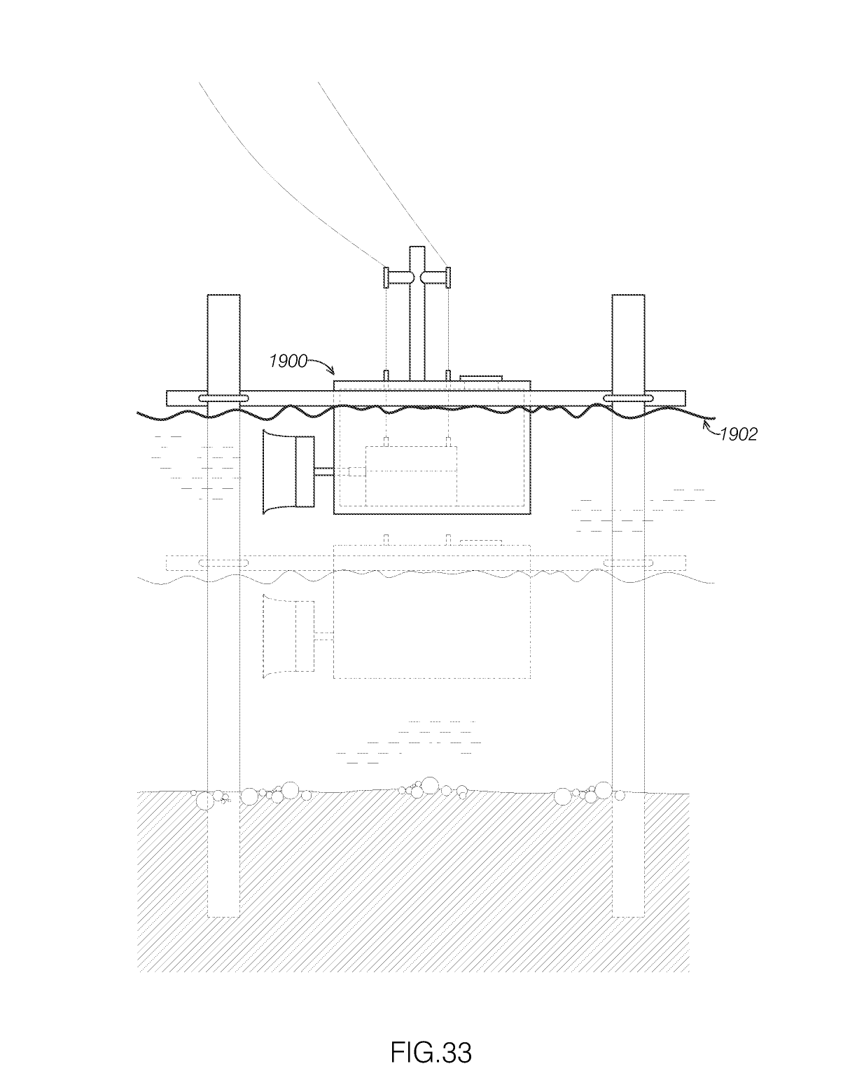

As FIG. 32 illustrates, nozzle 1970 additionally includes a second screen 1985 located over an opening proximate an egress side 1974 of nozzle 1970. Second screen 1985 restricts wildlife from inadvertently contacting rotor 1915 from egress side 1974. Screens implemented in this manner may be similar to any screen disclosed herein.

As FIG. 31 illustrates, electrical interface 1990 is substantially similar to electrical interface 1880, and is configured to distribute energy generated by generator 1925 to external power system 1904.

Although hydroelectric generator 1900 includes nozzle 1970 directing liquid toward rotor 1915, rotor-based designs that do not include a nozzle are equally within this disclosure.

Hydroelectric generator 1900 illustrates rotor 1915 being directly connected to generator 1925. This disclosure, however, additionally or alternatively contemplates designs that include a drivetrain, which may include a transmission and/or clutches, connected between a rotor and a generator.

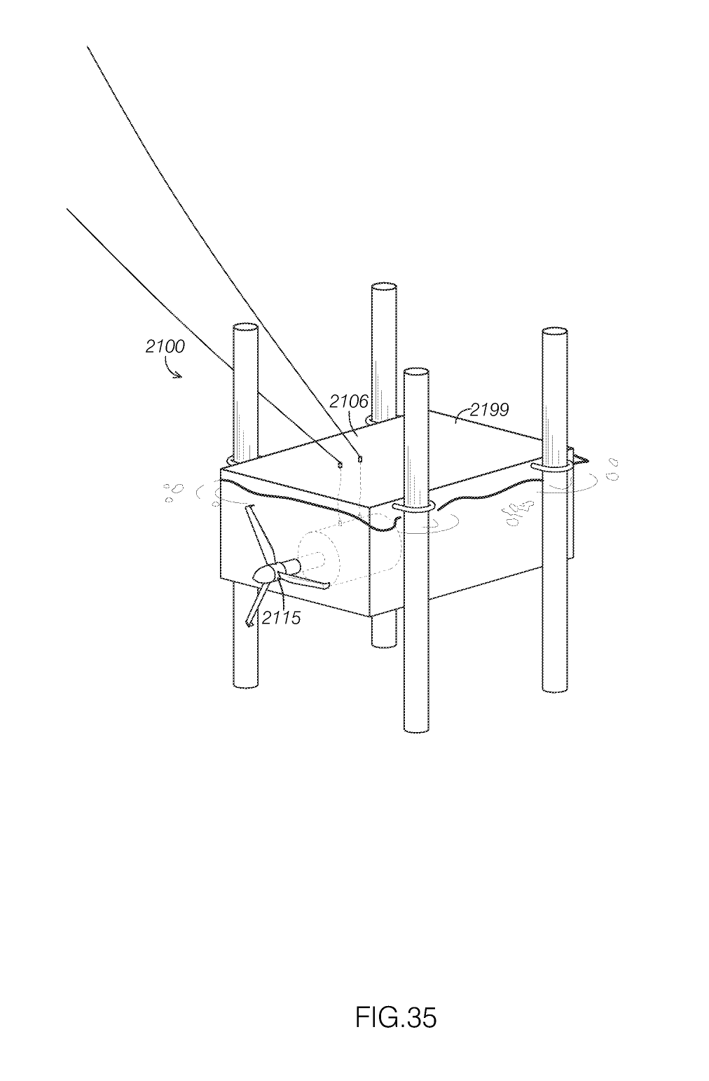

With reference to FIG. 34, an example of a hydroelectric generator, hydroelectric generator 2000, will now be described. Hydroelectric generator 2000 shares similar or identical features with hydroelectric generator 1800 that will not be redundantly explained. Rather, key distinctions between hydroelectric generator 2000 and hydroelectric generator 1800 will be described in detail and the reader should reference the discussion above for features substantially similar between the hydroelectric generators.

As FIG. 34 illustrates, hydroelectric generator 2000 is buoyantly supported on a liquid source 2002 by a platform 2006. Hydroelectric generator 2000 is configured to maintain a generation unit 2010 in liquid source 2002 at a selected depth as generation unit 2010 generates electricity, similar to hydroelectric generator 1800.

As FIG. 34 shows, however, hydroelectric generator 2000 includes a keel 2070 projecting from platform 2006. Keel 2070 includes a first projection 2072 and a second projection 2074. Keel 2070 directs water towards generation unit 2010, allowing hydroelectric generator 2000 to efficiently harness the potential energy contained in liquid source 2002. Additionally, first projection 2072 and second projection 2074 may be weighted to maintain platform 2006 in an upright position.

As FIG. 34 illustrates, a screen 2080 extends across the submerged portions of first projection 2072 and second projection 2074. This restricts wildlife from inadvertently contacting generation unit 2010 during operation.

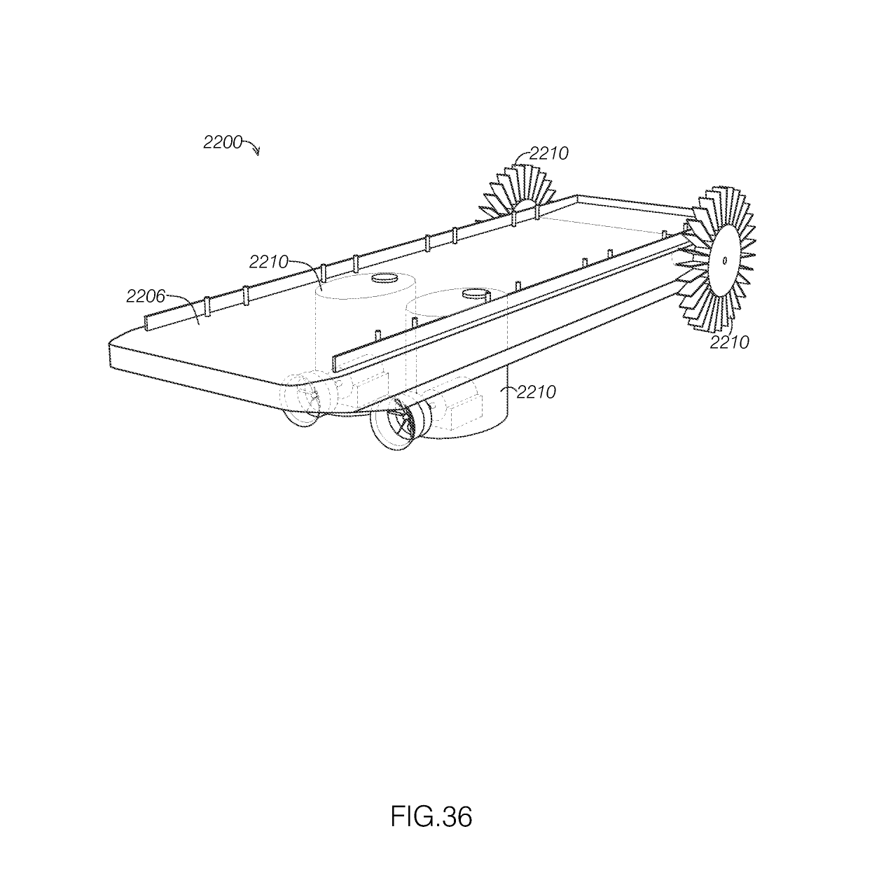

With reference to FIG. 35, an example of a hydroelectric generator, hydroelectric generator 2100, will now be described. Hydroelectric generator 2100 shares similar or identical features with hydroelectric generator 1900 that will not be redundantly explained. Rather, key distinctions between hydroelectric generator 2100 and hydroelectric generator 1900 will be described in detail and the reader should reference the discussion above for features substantially similar between the hydroelectric generators.

Hydroelectric generator 2100 includes a platform 2106 and a generation unit 2110, substantially similar to hydroelectric generator 1900. However, as FIG. 35 shows, platform 2106 includes a buoyant enclosure 2199 that encloses substantially all of hydroelectric generator 2100 except a rotor assembly 2115. Rotor assembly 2115 includes a rotor projecting from buoyant enclosure 2199 that drives an enclosed generator. Buoyant enclosure 2199 is buoyant and is substantially water tight to protect electrical components enclosed therein.

As FIG. 35 illustrates, rotor assembly 2115 does not include a nozzle 1970 like generation unit 1910. This disclosure contemplates rotor-driven generators nozzle-enclosed rotors, non-enclosed rotors, or any combination thereof.

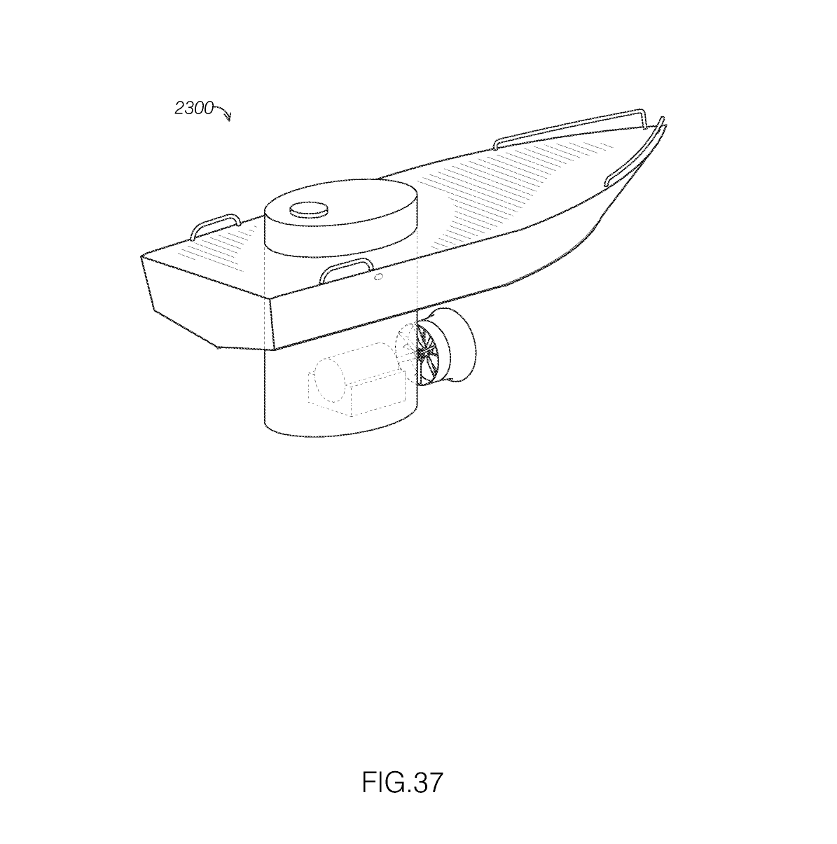

With reference to FIG. 36, certain hydroelectric generators, including a hydraulic generator 2200, may include multiple generation units 2210 affixed to a platform 2206. Additionally, platforms, similar to platform 2206, may define a barge platform. Additionally, as FIG. 37 illustrates through an example of a hydroelectric generator, hydroelectric generator 2300, this disclosure specifically contemplates hydroelectric generators configured with rotor-based generation units attached to boat-like platforms. Similarly, this disclosure specifically contemplates waterwheel-based generation units attached to platforms similar to platform 1906.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A hydroelectric generator for harnessing potential energy from a flowing liquid source with a varying surface level, the hydroelectric generator comprising:
a platform with a buoyancy selected to remain suspended in the liquid source at a selected depth; and
a generation unit fixed to the platform, the generation unit including:
a turbine in the liquid source, the turbine including a blade extending in the liquid source and configured to rotate when driven by the current impinging on the blade;
a generator drivingly connected to the turbine, the generator configured to generate electricity in response to the turbine rotating; and
an electrical interface connected to the generator, the electrical interface configured to connect to an external power system.

2. The hydroelectric generator of claim 1, wherein the turbine defines a waterwheel.

3. The hydroelectric generator of claim 1, further comprising:
an anchor; and
an anchor connector connecting the anchor to the platform.

4. The hydroelectric generator of claim 2, wherein the anchor connector defines a line extending from the anchor to the platform.

5. The hydroelectric generator of claim 2, wherein:
the anchor defines a first anchor; and
the anchor connector defines a first anchor connector;
further comprising:
a second anchor horizontally spaced from the first anchor; and
a second anchor connector connecting the second anchor to the platform.

6. The hydroelectric generator of claim 1, further comprising:
a post extending from the bottom of the liquid source to beyond the liquid source's surface level; and
a post receiver connected to the platform and configured to slidingly receive the post.

7. The hydroelectric generator of claim 1, further comprising a screen enclosing the submerged portion of the turbine.

8. The hydroelectric generator of claim 1, wherein the platform defines a hull extending into the liquid source.

9. The hydroelectric generator of claim 1, further comprising an electric storage unit electrically connected to the generation unit, the electric storage unit configured to store generated electricity.

10. The hydroelectric generator of claim 1, further comprising a drivetrain connected between the turbine and the generator

11. The hydroelectric generator of claim 10, wherein the drivetrain includes:
a first drivetrain wheel attached to the turbine and defining a first radius;
a second drivetrain wheel attached to the generator and defining a second radius smaller than the first radius.

12. The hydroelectric generator of claim 1, further comprising a wind generator supported on the platform.

13. A hydroelectric generator for harnessing potential energy from a flowing liquid source with a varying surface level, the hydroelectric generator comprising:
a platform with a buoyancy selected to maintain the platform suspended in the liquid source at a selected depth; and
a generation unit fixed to the platform, the generation unit including:
a rotor submerged in the liquid source, the rotor configured to be driven by the current;
a generator drivingly connected to the rotor, the generator configured to generate electricity as the rotor is driven;
an electrical interface connected to the generator, the electrical interface configured to connect to an external power system.

14. The hydroelectric generator of claim 13, further comprising a nozzle enclosing the rotor within an enclosed chamber.

15. The hydroelectric generator of claim 14, wherein the nozzle defines an ingress opening upstream of the rotor;
further comprising a screen covering the ingress opening.

16. The hydroelectric generator of claim 14, wherein the nozzle defines an egress opening downstream of the rotor;
further comprising a screen covering the egress opening.

17. The hydroelectric generator of claim 13 further comprising a drivetrain connected between the rotor and the generator.

18. The hydroelectric generator of claim 13, wherein the platform includes an enclosure enclosing the generator.

19. A hydroelectric generator for harnessing potential energy from a liquid source producing a current, the hydroelectric generator comprising:
a platform;
a first projection extending from the platform into the liquid source;
a second projection extending from the platform into the liquid source, the second projection spaced from the first projection;
a channel between the first projection and the section projection;
a generation unit fixed to the platform, the generation unit including:
a turbine at least partially disposed in the channel; and
a generator drivingly connected to the turbine, the generator configured to generate electricity as the turbine is driven.

20. The hydroelectric generator of claim 19, wherein the channel tapers toward the turbine as it approaches the turbine.

21. The hydroelectric generator of claim 19, further comprising a screen extending from the first projection to the second projection.

22. The hydroelectric generator of claim 19, wherein the platform has a buoyancy selected to maintain the platform suspended in the liquid source at a selected depth.

23. The hydroelectric generator of claim 19, wherein the first projection is denser than the liquid source.
